(19) United States
(12) Patent Application Publication
(10) Pub. No.: US 2016/0150500 A1
(43) Pub. Date: May 26, 2016

(54) HIGH ACCURACY OFDMA DOWNLINK RTT MEASUREMENT

(71) Applicant: QUALCOMM Incorporated, San Diego, CA (US)

(72) Inventors: Meghna Agrawal, Sunnyvale, CA (US); Ning Zhang, Saratoga, CA (US); Xiaoxin Zhang, Fremont, CA (US); Youhan Kim, San Jose, CA (US); Praveen Dua, Cupertino, CA (US); Carlos Horacio Aldana, Mountain View, CA (US)

(21) Appl. No.: 14/939,278

(22) Filed: Nov. 12, 2015

Related U.S. Application Data
(60) Provisional application No. 62/082,533, filed on Nov. 20, 2014.

(51) Int. Cl. H04W 64/00; H04W 72/04; H04L 5/00

(52) U.S. Cl. CPC H04W 64/00; H04L 5/0007; H04W 72/0453; H04W 84/12

(57) ABSTRACT

Methods and apparatuses are disclosed that may perform simultaneous ranging operations between a requester device and each of a plurality of target devices using OFDMA-based frame exchanges while maintaining a level of accuracy comparable to ranging operations that do not use OFDMA-based frame exchanges. Tone interleaving may be used so that the ranging devices may estimate channel conditions for the full frequency spectrum of the wireless medium. For example, a unique set of two or more non-adjacent groups of OFDM sub-carrier frequencies may be allocated to each of the plurality of target devices for ranging operations.

### CROSS-REFERENCE TO RELATED APPLICATION

This application claims priority to U.S. Provisional Patent Application No. 62/082,533, titled “High Accuracy OFDMA Downlink RTT Measurement,” filed Nov. 20, 2014, which is hereby incorporated by reference in its entirety.

### TECHNICAL FIELD

The example embodiments relate generally to wireless networks, and specifically to transit timing operations performed between Wi-Fi enabled devices using orthogonal frequency-division multiple access (OFDMA).

### BACKGROUND OF RELATED ART

The recent proliferation of Wi-Fi access points in wireless local area networks (WLANs) has made it possible for navigation systems to use these access points for position determination, especially in areas where there are a large concentration of active Wi-Fi access points (e.g., urban cores, shopping centers, office buildings, and so on). For example, a client device or station (STA) such as a cell phone or tablet computer can use the round trip time (RTT) of signals transmitted to and from the access points (APs) to calculate the distances between the STA and the APs. Once the distances between the STA and three APs are calculated, the location of the STA can be estimated using trilateration techniques.

More generally, the distance between a pair of devices may be determined using the RTT of signals exchanged between the devices. Additionally, a third wireless device may passively listen to the signals exchanged between the pair of devices, and from that exchange determine the third device's own distance from the transmitting devices. Because ranging operations are becoming more important, it is desirable to increase the accuracy of ranging operations using minimal capacity of the wireless medium.

### SUMMARY

This Summary is provided to introduce in a simplified form a selection of concepts that are further described below in the Detailed Description. This Summary is not intended to identify key features or essential features of the claimed subject matter, nor is it intended to limit the scope of the claimed subject matter.

Aspects of the disclosure are directed to apparatuses and methods for performing ranging operations between a first wireless device (e.g., a requester device) and a number of other wireless devices (e.g., target devices) using OFDMA-based frame exchanges. In one example, a method for performing simultaneous ranging operations between a wireless device and each of a plurality of target devices using OFDMA is disclosed. The method may include transmitting a fine timing measurement (FTM) frame to the plurality of target devices; determining a time of departure (TOD) of the FTM frame; receiving, from each of the plurality of target devices, a corresponding acknowledgement (ACK) frame; determining a time of arrival (TOA) of each of the received ACK frames; transmitting a trigger frame requesting an FTM response from each of the plurality of target devices; receiving, from each of the plurality of target devices, a corresponding FTM response frame that includes the TOA of the FTM frame at the target device and includes the TOD of the corresponding ACK frame from the target device; and determining a round-trip time (RTT) value between the wireless device and each of the plurality of target devices based, at least in part, on the TOD of the FTM frame, the TOA of the FTM frame at the target device, the TOD of the corresponding ACK frame from the target device, and the TOA of the corresponding ACK frame at the wireless device.

In another example, an apparatus for performing simultaneous ranging operations with each of a plurality of target devices using OFDMA is disclosed. The apparatus may include means for transmitting a fine timing measurement (FTM) frame to the plurality of target devices; means for determining a time of departure (TOD) of the FTM frame; means for receiving, from each of the plurality of target devices, a corresponding acknowledgement (ACK) frame; means for determining a time of arrival (TOA) of each of the received ACK frames; means for transmitting a trigger frame requesting an FTM response from each of the plurality of target devices; means for receiving, from each of the plurality of target devices, a corresponding FTM response frame that includes the TOA of the FTM frame at the target device and includes the TOD of the corresponding ACK frame from the target device; and means for determining a round-trip time (RTT) value between the wireless device and each of the plurality of target devices based, at least in part, on the TOD of the FTM frame, the TOA of the FTM frame at the target device, the TOD of the corresponding ACK frame from the target device, and the TOA of the corresponding ACK frame at the wireless device.

In another example, an apparatus for performing simultaneous ranging operations with each of a plurality of target devices using OFDMA is disclosed. The apparatus may include one or more processors and a memory configured to store instructions. Execution of the instructions by the one or more processors may cause the wireless device to transmit a fine timing measurement (FTM) frame to the plurality of target devices; determine a time of departure (TOD) of the FTM frame; receive, from each of the plurality of target devices, a corresponding acknowledgement (ACK) frame; determine a time of arrival (TOA) of each of the received ACK frames; transmit a trigger frame requesting an FTM response from each of the plurality of target devices; receive, from each of the plurality of target devices, a corresponding FTM response frame that includes the TOA of the FTM frame at the target device and includes the TOD of the corresponding ACK frame from the target device; and determine a round-trip time (RTT) value between the wireless device and each of the plurality of target devices based, at least in part, on the TOD of the FTM frame, the TOA of the FTM frame at the target device, the TOD of the corresponding ACK frame from the target device, and the TOA of the corresponding ACK frame at the wireless device.

### BRIEF DESCRIPTION OF THE DRAWINGS

The example embodiments are illustrated by way of example and are not intended to be limited by the figures of the accompanying drawings. Like numbers reference like elements throughout the drawings and specification.

FIG. 1A is a sequence diagram depicting an example ranging operation.

FIG. 1B is a sequence diagram depicting another example ranging operation.

FIG. 2 is a diagram of an example subcarrier allocation using OFDMA.

FIG. 3 is a diagram of a subcarrier allocation using tone interleaving in OFDMA in accordance with some embodiments.

FIG. 4 is a sequence diagram depicting a ranging operation in accordance with some embodiments.

FIG. 5 is a sequence diagram depicting a ranging operation in accordance with other embodiments.

FIG. 6 is a sequence diagram depicting a ranging operation in accordance with other embodiments.

FIG. 7 is a sequence diagram depicting a ranging operation in accordance with other embodiments.

FIG. 8 is a sequence diagram depicting a ranging operation in accordance with other embodiments.

FIG. 9 is a block diagram of a WLAN system within which the example embodiments may be implemented.

FIG. 10 is a block diagram of a wireless device in accordance with some embodiments.

FIG. 11 shows an illustrative flowchart depicting the ranging operation of FIG. 4 in accordance with the example embodiments.

FIG. 12 shows an illustrative flowchart depicting the ranging operation of FIG. 5 in accordance with the example embodiments.

FIG. 13 shows an illustrative flowchart depicting the ranging operation of FIG. 6 in accordance with the example embodiments.

FIG. 14 shows an illustrative flowchart depicting the ranging operation of FIG. 7 in accordance with the example embodiments.

FIG. 15 shows an illustrative flowchart depicting the ranging operation of FIG. 8 in accordance with the example embodiments.

FIGS. 16A-16B depict example frame formats for ACK frames in accordance with some embodiments.

FIGS. 17A-17B depict example frame formats for ACK frames in accordance with other embodiments.

### DETAILED DESCRIPTION

The example embodiments are described below in the context of ranging operations performed by and between Wi-Fi enabled devices for simplicity only. It is to be understood that the example embodiments are equally applicable for performing ranging operations using signals of other various wireless standards or protocols, and for performing ranging operations between various devices (e.g., between a STA and a wireless AP, between APs, and so on). As used herein, the terms WLAN and Wi-Fi can include communications governed by the IEEE 802.11 standards, Bluetooth, HiperLAN (a set of wireless standards, comparable to the IEEE 802.11 standards, used primarily in Europe), and other technologies having relatively short radio propagation range. Thus, the terms “WLAN” and “Wi-Fi” may be used interchangeably herein. In addition, although described below in terms of an infrastructure WLAN system including one or more APs and a number of STAs, the example embodiments are equally applicable to other WLAN systems including, for example, multiple WLANs, peer-to-peer (or Independent Basic Service Set) systems, Wi-Fi Direct systems, and/or Hotspots. In addition, although described herein in terms of exchanging data frames between wireless devices, the example embodiments may be applied to the exchange of any data unit, packet, and/or frame between wireless devices. Thus, the term “frame” may include any frame, packet, or data unit such as, for example, protocol data units (PDUs), MAC protocol data units (MPDUs), and physical layer convergence procedure protocol data units (PPDUs). The term “A-MPDU” may refer to aggregated MPDUs.

The terminology used herein is for the purpose of describing particular aspects only and is not intended to be limiting of the aspects. As used herein, the singular forms “a,” “an” and “the” are intended to include the plural forms as well, unless the context clearly indicates otherwise. It will be further understood that the terms “comprises,” “comprising,” “includes” or “including,” when used herein, specify the presence of stated features, integers, steps, operations, elements, or components, but do not preclude the presence or addition of one or more other features, integers, steps, operations, elements, components, or groups thereof. Moreover, it is understood that the word “or” has the same meaning as the Boolean operator “OR,” that is, it encompasses the possibilities of “either” and “both” and is not limited to “exclusive or” (“XOR”), unless expressly stated otherwise. It is also understood that the symbol “I” between two adjacent words has the same meaning as “or” unless expressly stated otherwise. Moreover, phrases such as “connected to,” “coupled to” or “in communication with” are not limited to direct connections unless expressly stated otherwise.

Further, many aspects are described in terms of sequences of actions to be performed by, for example, elements of a computing device. It will be recognized that various actions described herein can be performed by specific circuits, for example, central processing units (CPUs), graphic processing units (GPUs), digital signal processors (DSPs), application specific integrated circuits (ASICs), field programmable gate arrays (FPGAs), or various other types of general purpose or special purpose processors or circuits, by program instructions being executed by one or more processors, or by a combination of both. Additionally, these sequence of actions described herein can be considered to be embodied entirely within any form of computer readable storage medium having stored therein a corresponding set of computer instructions that upon execution would cause an associated processor to perform the functionality described herein. Thus, the various aspects of the disclosure may be embodied in a number of different forms, all of which have been contemplated to be within the scope of the claimed subject matter. In addition, for each of the aspects described herein, the corresponding form of any such aspects may be described herein as, for example, “logic configured to” perform the described action.

In the following description, numerous specific details are set forth such as examples of specific components, circuits, and processes to provide a thorough understanding of the present disclosure. Also, in the following description and for purposes of explanation, specific nomenclature is set forth to provide a thorough understanding of the example embodiments. However, it will be apparent to one skilled in the art that these specific details may not be required to practice the example embodiments. In other instances, well-known circuits and devices are shown in block diagram form to avoid obscuring the present disclosure. The term “coupled” as used herein means connected directly to or connected through one or more intervening components or circuits. Any of the signals provided over various buses described herein may be time-multiplexed with other signals and provided over one or more common buses. Additionally, the interconnection between circuit elements or software blocks may be shown as buses or as single signal lines. Each of the buses may alternatively be a single signal line, and each of the single signal lines may alternatively be buses, and a single line or bus might represent any one or more of a myriad of physical or logical mechanisms for communication between components. The example embodiments are not to be construed as limited to specific examples described herein but rather to include within their scopes all embodiments defined by the appended claims.

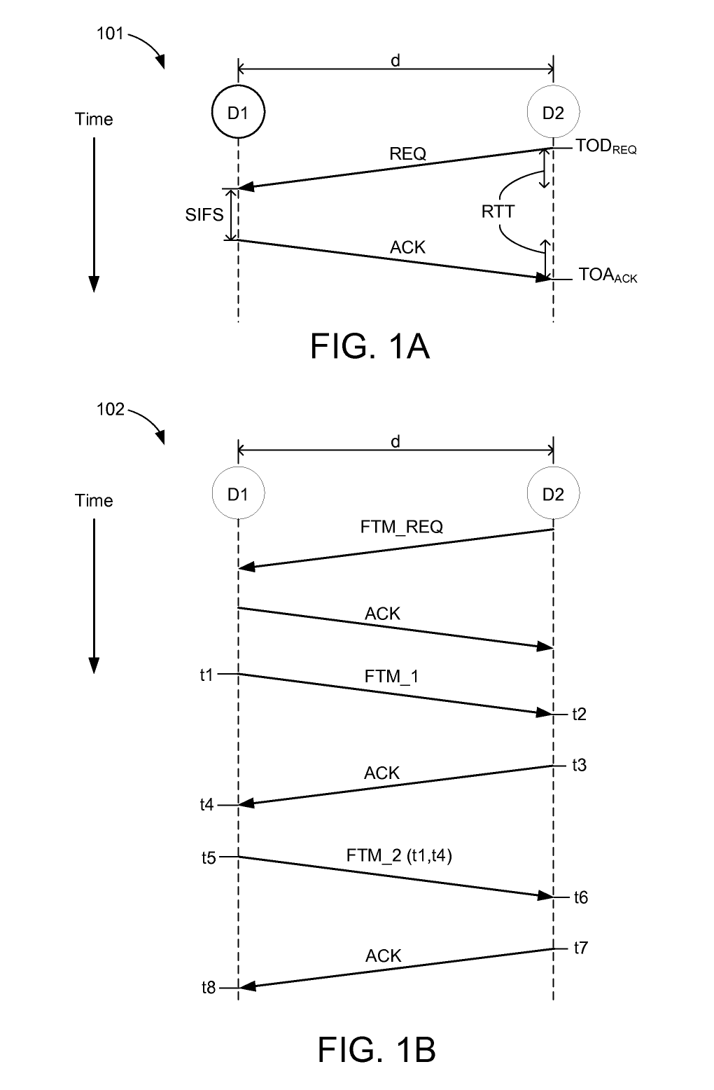

As mentioned above, the distance between a pair of devices may be determined using the RTT of signals exchanged between the devices. For example, referring to the sequence diagram 101 of FIG. 1A, the distance (d) between a first device (D1) and a second device (D2) may be estimated as d=c*RTT/2, where c is the speed of light, and RTT is the summation of the actual signal propagation times of a request (REQ) frame and an acknowledgement (ACK) frame exchanged between devices D1 and D2. More specifically, device D2 can estimate the RTT value using the time of departure (TOD) of the REQ frame from device D2, the time of arrival (TOA) of the ACK frame received by device D2, and the SIFS duration of device D1. The SIFS duration, which stands for the short interframe space duration, indicates the duration of time between device D1 receiving the REQ frame and transmitting the ACK frame. The SIFS duration, a range of values for which are provided by the IEEE 802.11 standards, provides Wi-Fi enabled devices time to switch its transceivers from a receive mode (e.g., to receive the REQ frame) to a transmit mode (e.g., to transmit the ACK frame).

Because different make-and-models (and sometimes even same make-and-models) of communication devices have different processing delays, the precise value of SIFS may vary between devices (and even between successive frame receptions/transmissions in the same device). As a result, the value of SIFS is typically estimated, which often leads to errors in estimating the distance between two devices. More specifically, the IEEE 802.11 standards define the SIFS duration as 10 us+/−900 ns at 2.4 GHz, 16 us+/−900 ns at 5 GHz, and 3 us+/−900 ns at 60 GHz. These “standard” SIFS durations include tolerances that may decrease the accuracy of RTT estimates. For example, even if the SIFS duration of device D1 may be estimated within +/−25 ns, a ranging error of +/−7.5 meters may result (which may be unacceptable for indoor positioning systems).

To reduce ranging errors resulting from uncertainties in the value of SIFS, recent revisions to the IEEE 802.11 standards call for each ranging device to capture timestamps of incoming and outgoing frames so that the value of RTT may be determined without SIFS. For example, FIG. 1B shows a sequence diagram 102 depicting a ranging operation between devices D1 and D2 performed using Fine Timing Measurement (FTM) frames in accordance with the IEEE 802.11 REVmc standards. For the example of FIG. 1B, device D2 requests the ranging operation; thus, device D2 is the initiator device and device D1 is the responder device. Device D2 first transmits a FTM_REQ frame to device D1, which responds with an ACK frame. The exchange of the FTM_REQ frame and ACK frame is a handshake process that not only signals an intent to perform a ranging operation but also allows devices D1 and D2 to determine whether each device supports capturing timestamps. Assuming that both devices D1 and D2 support capturing timestamps, device D1 initiates the ranging operation by transmitting a first FTM frame (FTM_1) to device D2, and captures the TOD of FTM_1 at time t1. Device D2 captures the TOA of FTM_1 at time t2. Device D2 responds with an ACK frame, and captures the TOD of the ACK frame at time t3. Device D1 receives the ACK frame and captures the TOA of the ACK frame at time t4. At time t5, device D1 transmits to device D2 a second FTM frame (FTM_2) that includes the timestamps captured at times t1 and t4. Device D2 receives the FTM_2 frame at time t6, and may capture its timestamp. Device D2 transmits an ACK frame at time t7. Device D1 receives the ACK frame at time t8.

Upon receiving the FTM_2 frame at time t6, device D2 has timestamp values for times t1, t2, t3, and t4 that correspond to the TOD of FTM_1 from device D1, the TOA of FTM_1 at device D2, the TOD of the ACK frame from device D2, and the TOA of the ACK frame at device D1, respectively. Thereafter, device D2 may determine RTT as (t4−t3)+(t2−t1). Because the RTT estimate does not involve estimating SIFS for either device D1 or device D2, the RTT estimate does not involve errors resulting from uncertainties of SIFS durations.

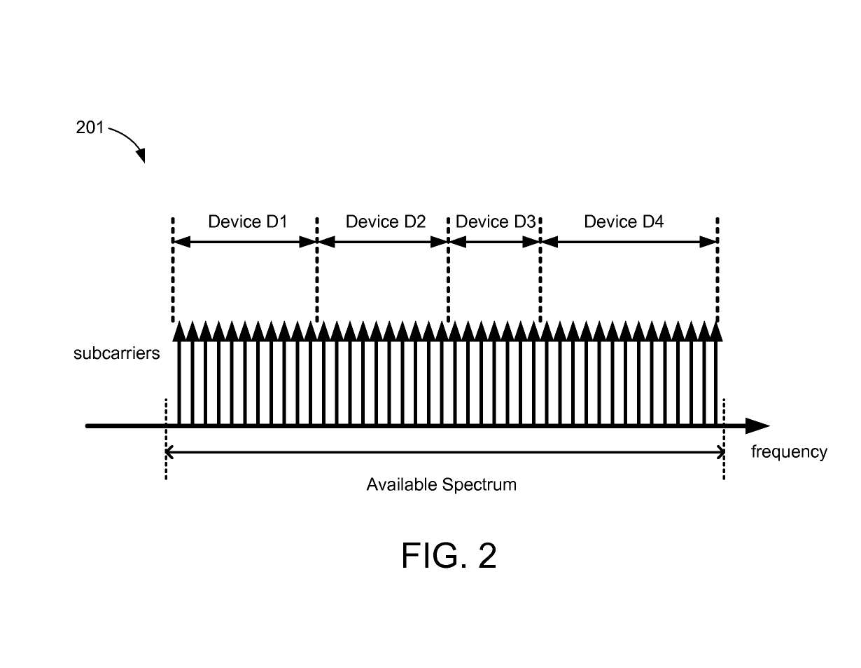

Wi-Fi enabled devices such as devices D1 and D2 may communicate using an Orthogonal Frequency-Division Multiple Access (OFDMA) modulation scheme. OFDMA allows multiple users (e.g., multiple devices) to access a wireless medium at the same time using Orthogonal Frequency-Division Multiplexing (OFDM) signals. Specifically, for a wireless network using OFDMA modulation scheme, different frequency subcarriers are assigned (e.g., by an AP) to different devices (e.g., STAs) at a given point in time, thereby allowing each device in the wireless network to concurrently access the wireless medium using its assigned subcarriers (e.g., tones). For example, FIG. 2 depicts a hypothetical allocation 201 of subcarriers to 4 devices D1-D4 associated with a wireless network. Typically, each of devices D1-D4 is allocated a contiguous group or subset of subcarrier tones, as depicted in FIG. 2. Although RTT-based ranging operations are not currently defined by the IEEE 802.11 standards for systems using OFDMA modulation schemes, Applicant has discovered that OFDMA modulation schemes may be leveraged to achieve more accurate RTT values (and thus more accurate distance measurements) than current solutions such as, for example, the ranging operations depicted in FIGS. 1A-1B.

Before discussing the details of example embodiments disclosed herein, it is noted that current IEEE 802.11 standards typically use separate frame exchanges for each RTT measurement in a ranging operation. For example, the example ranging operation of FIG. 1B (which as described above does not need to estimate the SIFS duration of device D1) uses 6 frame exchanges to determine the RTT between devices D1 and D2. Thus, it would be advantageous to minimize the number of frame exchanges associated with determining RTT values between devices.

Because devices in an OFDMA-based wireless network may be assigned different tones, a plurality of devices may simultaneously share the wireless medium, with each device using a different portion of the wireless medium's frequency spectrum. Although devices in an OFDMA-based wireless network may access and transmit data on the wireless medium at the same time, each device is limited to the portion of the frequency spectrum allocated thereto. As a result, each device may estimate channel conditions using only its allocated portion of the frequency spectrum of the wireless network. In contrast, devices in an OFDM-based wireless network may use the entire frequency spectrum of the wireless medium (and thus may estimate channel conditions for the entire frequency spectrum of the wireless medium), albeit at the expense of having to share access to the wireless medium.

Although devices in an OFDMA-based wireless network may access and transmit data on the shared wireless medium at the same time, the limited frequency bandwidth allocated to each device in the OFDMA-based wireless network may reduce the accuracy of ranging operations, for example, as compared with ranging operations performed using frames transmitted using the entire frequency spectrum of the shared wireless network (e.g., such as ranging operations performed in an OFDM-based wireless network). More specifically, referring also to FIG. 1B, the accuracy of the RTT value between device D1 and device D2 may be proportional to the frequency bandwidth available for transmitting the FTM frame and the ACK frame. As a result, ranging operations for which the FTM frame and the ACK frame are transmitted using a relatively large portion of the frequency spectrum may be more accurate than ranging operations for which the FTM frame and the ACK frame are transmitted using a relatively small portion of the frequency spectrum. Thus, it would be desirable for an OFDMA-based wireless network to perform ranging operations with a level of accuracy similar to that achieved in OFDM-based wireless networks.

In accordance with the example embodiments, methods and apparatuses are disclosed that may perform simultaneous ranging operations between a first wireless device (e.g., a requester device) and each of a plurality of second wireless devices (e.g., target devices) using OFDMA-based frame exchanges while maintaining a level of accuracy comparable to ranging operations that do not use OFDMA-based frame exchanges. For at least some embodiments, tone interleaving may be used so that the ranging devices may estimate channel conditions for the full frequency spectrum of the wireless medium. For at least some implementations, a unique set of two or more non-adjacent groups of orthogonal frequency-division multiplexing (OFDM) sub-carrier frequencies may be allocated to each of the plurality of target devices for ranging operations.

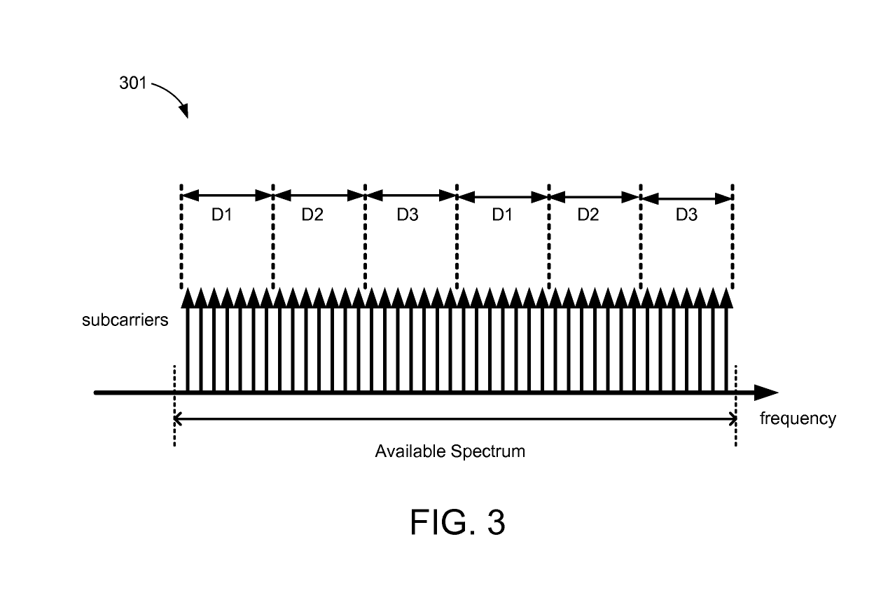

Referring to FIG. 3, an example subcarrier allocation 301 uses tone interleaving to allocate subcarriers to devices D1-D3 in interleaved groups rather than allocating one contiguous group of subcarriers to each device (e.g., as depicted in FIG. 2).

For example, if N subcarriers are to be allocated to three devices D1-D3, tone interleaving may allocate the first B subcarriers to device D1, the second B subcarriers to device D2, the third B subcarriers to device D3, the fourth B subcarriers to device D1, the fifth B subcarriers to device D2, the sixth B subcarriers to device D3, and so on, until all subcarriers are allocated to the three devices D1-D3. The number B is an integer greater than or equal to 1. For at least some embodiments, the number of B may be kept relatively low (e.g., below a threshold) so that each of devices D1-D3 is allocated tones across the entire frequency spectrum of the wireless medium. For the example of FIG. 3, the value of B=7 (although other values of B may be used). Tone interleaving may be beneficial to timing accuracy using OFDMA because devices may interpolate and estimate channel frequency responses for the full bandwidth of the channel, instead of merely one portion of the channel, as with standard subcarrier allocation.

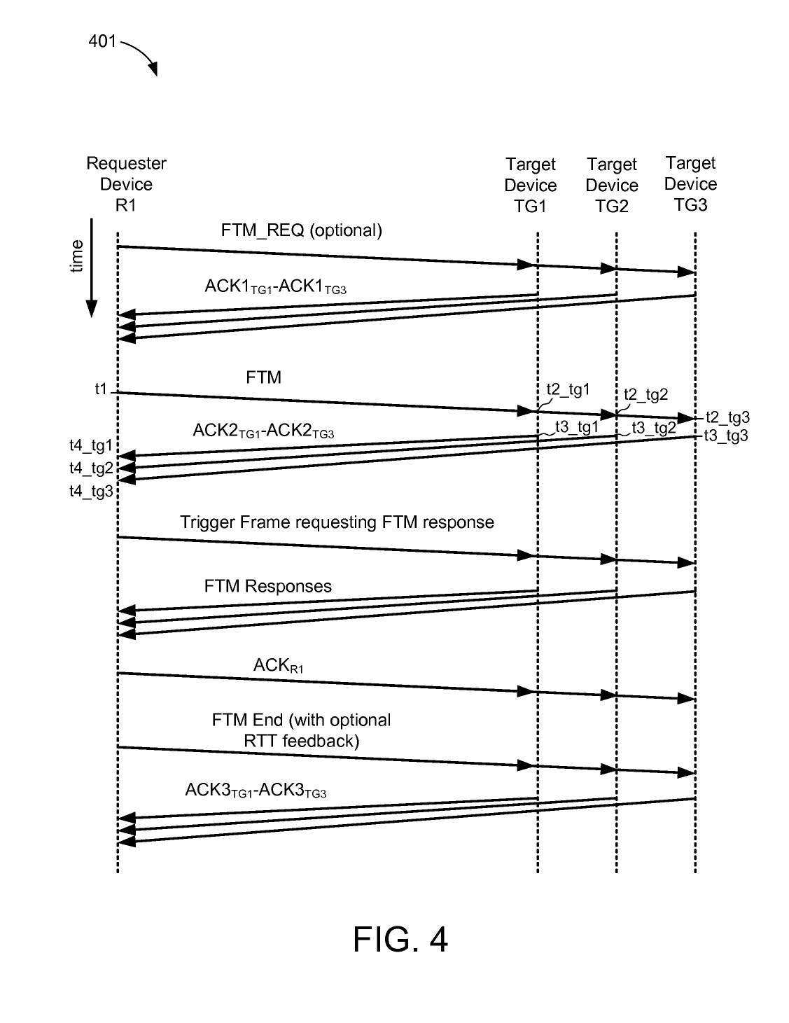

FIG. 4 depicts a sequence diagram 401 of a downlink OFDMA ranging operation using fine timing measurement (FTM) frames in accordance with some embodiments. For some implementations, the requester device R1 (or other suitable device) may allocate a unique set of two or more non-adjacent groups of OFDM sub-carrier frequencies to each of the target devices TG1-TG3, for example, as described above with respect to FIG. 3. Similarly, the requester device R1 may transmit frames to the target devices TG1-TG3 using two or more non-adjacent groups of OFDM sub-carrier frequencies. As a result, frames exchanged between the requester device R1 and each of the target devices TG1-TG3 may utilize a relatively large portion of the frequency spectrum of the shared wireless medium, for example, as compared with a relatively small portion of the frequency spectrum of the shared wireless medium typically associated with OFDMA modulation schemes (e.g., as described above with respect to FIG. 2). In this manner, OFDMA-based ranging operations performed in accordance with the example embodiments may provide more accurate RTT values (and thus more accurate distance measurements) than OFDMA-based ranging operations that allocate a single group of contiguous OFDM sub-carrier frequencies to each target device.

As shown in FIG. 4, the operation may begin with an FTM_REQ frame transmitted using OFDMA from a requester device R1 to target devices TG1-TG3. The FTM_REQ frame is optional, but if the FTM_REQ frame is transmitted, then each of the target devices TG1-TG3 may acknowledge receiving the FTM_REQ frame by transmitting (to requester device R1) a corresponding ACK frame using OFDMA, as defined in the IEEE 802.11ax standards. For example, as depicted in FIG. 4, target device TG1 transmits ACK1_{TG1}, target device TG2 transmits ACK1_{TG2}, and target device TG3 transmits ACK1_{TG3}).

The requester device R1 uses OFDMA to transmit an FTM frame to the target devices TG1-TG3 (at time t1). If an FTM_REQ frame was previously sent from requester device R1 to the target devices TG1-TG3, then the requester device R1 may transmit the FTM frame only to those of target devices TG1-TG3 from which an acknowledgement (ACK) frame was received. In response to receiving the FTM frame, the target devices TG1-TG3 may each determine the time of arrival (TOA) of the FTM frame. For example, target device TG1 may capture a timestamp at time t2_tg1 indicative of the TOA of the FTM frame, target device TG2 may capture a timestamp at time t2_tg2 indicative of the TOA of the FTM frame, and target device TG3 may capture a timestamp at time t2_tg3 indicative of the TOA of the FTM frame. If tone interleaving is used, the target devices TG1-TG3 may use the entire preamble of the FTM frame to obtain a full-bandwidth channel estimation. If tone interleaving is not used, but a given target device supports full-bandwidth channel estimation, then the given target device may also use the entire preamble to obtain a full-bandwidth channel estimation. However, if tones are not interleaved, and the given target device does not support full-bandwidth channel estimation, then the given target device may only use the bandwidth allocated to it for TOA estimation.

Each of target devices TG1-TG3 responds to receiving the FTM frame by transmitting (to requester device R1) a corresponding ACK frame using OFDMA, as defined in the IEEE 802.11ax standards, and then captures the time of departure (TOD) of the corresponding ACK frame. For example, target device TG1 may capture a timestamp at time t3_tg1 indicative of the TOD of the ACK2_{TG1} frame transmitted to requester device R1, target device TG2 may capture a timestamp at time t3_tg2 indicative of the TOD of the ACK2_{TG2} frame transmitted to requester device R1, and target device TG3 may capture a timestamp at time t3_tg3 indicative of the TOD of the ACK2_{TG3} frame transmitted to requester device R1.

For at least some embodiments, the FTM frame transmitted by requester device R1 may include information to synchronize transmission of the acknowledgement frames ACK2_{TG1}-ACK2_{TG3} from the target devices TG1-TG3, respectively, at the same time (which may be specified in the FTM frame and/or in another suitable frame transmitted from the requester device R1 to the target devices TG1-TG3). For example, FIG. 4 depicts the ACK2_{TG1}-ACK2_{TG3} frames as being transmitted from respective target devices TG1-TG3 at the same time. Alternatively, the requester device R1 may already know the coarse propagation time of signals (e.g., FTM frames and ACK frames) between itself and each of the target devices TG1-TG3. The coarse propagation time of the signals may be used to synchronize transmission of the acknowledgement frames ACK2_{TG1}-ACK2_{TG3} from the target devices TG1-TG3, respectively. For other implementations, the FTM frame may include timing information that causes the target devices TG1-TG3 to transmit respective ACK2_{TG1}-ACK2_{TG3} frames at different times, in which case the timestamp values for t3_tg1-t3_tg3 may be different.

The requester device R1 may then determine the time of arrival (TOA) of each of the ACK frames received from target devices TG1-TG3. For example, requester device R1 may capture a timestamp at time t4_tg1 indicative of the TOA of ACK2_{TG1}, may capture a timestamp at time t4_tg2 indicative of the TOA of ACK2_{TG2}, and may capture a timestamp at time t4_tg3 indicative of the TOA of ACK2_{TG3}. If tone interleaving is used, the requester device R1 may use the tones allocated to a target device for channel estimation, and then use interpolation to estimate a full-bandwidth channel response for the target device. When tone interleaving is not used, then requester device R1 may only use the bandwidth allocated to a target device for TOA estimation.

Requester device R1 then transmits a Trigger frame (e.g., as defined in the IEEE 802.11ax standards) to the target devices TG1-TG3, using OFDMA. The Trigger frame indicates that the target devices TG1-TG3 are to transmit an FTM response frame using OFDMA.

The target devices TG1-TG3 may then transmit FTM response frames (using OFDMA) containing the t2 and t3 time stamps (e.g., where the t2 timestamps are indicative of the TOA of the FTM frame at respective target devices TG1-TG3, and the t3 timestamps are indicative of the TOD of the ACK2_{TG1}-ACK2_{TG3} frames from respective target devices TG1-TG3. More specifically, target device TG1 transmits timestamps for the TOA=t2_tg1 and for the TOD=t3_tg1 to requester device R1 in a first FTM response frame, target device TG2 transmits timestamps for the TOA=t2_tg2 and for the TOD=t3_tg2 to requester device R1 in a second FTM response frame, and target device TG3 transmits timestamps for the TOA=t2_tg3 and for the TOD=t3_tg3 to requester device R1 in a third FTM response frame. In some embodiments, the target devices TG1-TG3 may transmit FTM response frames that include SIFS delta values. A SIFS delta value may be defined as: (TOD of ACK−TOA of FTM frame)−standard SIFS. Requester device R1 then uses the received timing information to determine RTT values between itself and each of target devices TG1-TG3.

Requester device R1 may then transmit an FTM End frame to the target devices, using OFDMA. The FTM End frame may contain one or more fields to include the determined RTT values (e.g., thereby providing the determined RTT values to the target devices TG1-TG3 in the FTM End frame).

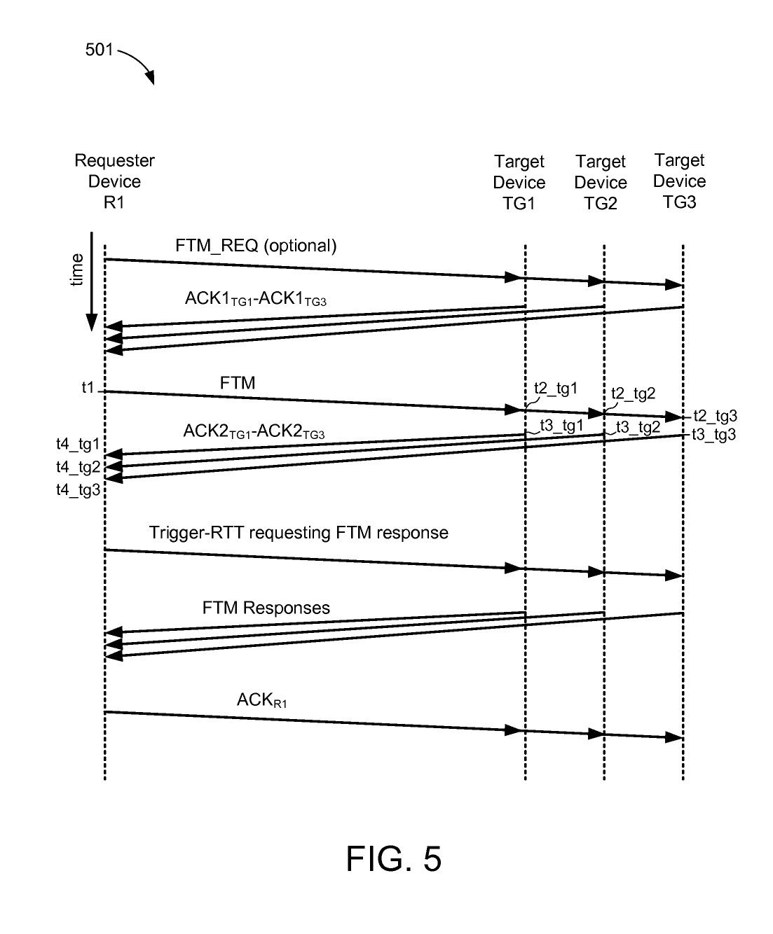

FIG. 5 depicts another sequence diagram 501 of a downlink OFDMA ranging operation using FTM frames in accordance with another embodiment. For some implementations, the requester device R1 may allocate a unique set of two or more non-adjacent groups of OFDM sub-carrier frequencies to each of the target devices TG1-TG3, for example, as described above with respect to FIG. 3. Similarly, the requester device R1 may transmit frames to the target devices TG1-TG3 using two or more non-adjacent groups of OFDM sub-carrier frequencies.

As in the RTT operation depicted in FIG. 4, the operation of FIG. 5 may begin with an FTM_REQ frame transmitted using OFDMA from requester device R1 to target devices TG1-TG3. The FTM_REQ frame is optional, but if the FTM_REQ frame is transmitted, then each of the target devices TG1-TG3 may acknowledge receiving the FTM_REQ frame by transmitting a corresponding ACK frame using OFDMA, as defined in the IEEE 802.11ax standards. For example, as depicted in FIG. 5, target device TG1 transmits ACK1_{TG1}, target device TG2 transmits ACK1_{TG2}) and target device TG3 transmits ACK1_{TG3}).

Requester device R1 uses OFDMA to transmit an FTM frame to the target devices TG1-TG3 (at time t1). If an FTM_REQ frame was previously sent from requester device R1 to the target devices TG1-TG3, then the requester device R1 may transmit the FTM frame only to those of target devices TG1-TG3 from which an acknowledgement (ACK) frame was received. In response to receiving the FTM frame, the target devices TG1-TG3 may each determine the TOA of the FTM frame. For example, target device TG1 may capture a timestamp at time t2_tg1 indicative of the TOA of the FTM frame, target device TG2 may capture a timestamp at time t2_tg2 indicative of the TOA of the FTM frame, and target device TG3 may capture a timestamp at time t2_tg3 indicative of the TOA of the FTM frame. If tone interleaving is used, the target devices TG1-TG3 may use the entire preamble of the FTM frame to obtain a full-bandwidth channel estimation. If tone interleaving is not used, but a given target device supports full-bandwidth channel estimation, then the given target device may also use the entire preamble to obtain a full-bandwidth channel estimation. However, if tones are not interleaved, and the given target device does not support full-bandwidth channel estimation, then the given target device may only use the bandwidth allocated to it for TOA estimation.

Each of target devices TG1-TG3 responds to receiving the FTM frame by transmitting (to requester device R1) a corresponding ACK frame using OFDMA, as defined in the IEEE 802.11ax standards, and then captures the TOD of the corresponding ACK frame. For example, target device TG1 may capture a timestamp at time t3_tg1 indicative of the TOD of the ACK2_{TG1} frame transmitted to requester device R1, target device TG2 may capture a timestamp at time t3_tg2 indicative of the TOD of the ACK2_{TG2} frame transmitted to requester device R1, and target device TG3 may capture a timestamp at time t3_tg3 indicative of the TOD of the ACK2_{TG3} frame transmitted to requester device R1.

The FTM frame transmitted by requester device R1 may include information to synchronize transmission of the ACK frames ACK2_{TG1}-ACK2_{TG3} from the target devices TG1-TG3, respectively. The ACK2_{TG1}-ACK2_{TG3} frames are depicted in the example of FIG. 5 as being transmitted from respective target devices TG1-TG3 at the same time; for other embodiments, the ACK2_{TG1}-ACK2_{TG3} frames may be transmitted from respective target devices TG1-TG3 at different times. Alternatively, the requester device R1 may already know the coarse propagation time of signals (e.g., FTM frames and ACK frames) between itself and the target devices TG1-TG3, which may be used to synchronize transmission of the ACK_{TG1}-ACK_{TG3} frames from the target devices TG1-TG3, respectively. For other implementations, the timestamp values for t3_tg1-t3_tg3 may be different, for example, because the acknowledgement frames ACK2_{TG1}-ACK2_{TG3} may be transmitted from respective target devices TG1-TG3 at different times.

The requester device R1 may then determine the TOA of each of the ACK frames ACK2_{TG1}-ACK2_{TG3} received from respective target devices TG1-TG3. For example, requester device R1 may capture a timestamp at time t4_tg1 indicative of the TOA of ACK2_{TG1}, may capture a timestamp at time t4_tg2 indicative of the TOA of ACK2_{TG2}, and may capture a timestamp at time t4_tg3 indicative of the TOA of ACK2_{TG3}. If tone interleaving is used, the requester device R1 may use the tones allocated to a target device for channel estimation, and then use interpolation to estimate a full-bandwidth channel response for the target device. When tone interleaving is not used, then requester device R1 may only use the bandwidth allocated to a target device for TOA estimation.

Next, the requester device R1 may transmit a Trigger-RTT frame to the target devices TG1-TG3 using OFDMA. The Trigger-RTT frame may include one or more fields for sending delay information to the target devices TG1-TG3. For at least some embodiments, the delay information may be a delay value indicative of the time between requester device R1 receiving an ACK1 frame and requester device R1 transmitting the FTM frame. The delay value, which for some implementations may refer to the “turn-around time” of the requester device R1, may be expressed as: (TOA of ACK frame−TOD of FTM frame)−standard SIFS. The target devices TG1-TG3 may determine RTT values by using the delay value included in the Trigger-RTT frame. The Trigger-RTT frame may include information to synchronize the FTM response frames transmitted by the target devices TG1-TG3 (e.g., as defined in the IEEE 802.11 ax standards), and may also include information indicating that each of the target devices TG1-TG3 is to transmit an FTM response frame using OFDMA.

The target devices TG1-TG3 may then transmit FTM response frames (using OFDMA) containing the t2 and t3 time stamps (e.g., where the t2 timestamps are indicative of the TOA of the FTM frame at respective target devices TG1-TG3, and the t3 timestamps are indicative of the TOD of the ACK2_{TG1}-ACK2_{TG3} frames from respective target devices TG1-TG3). More specifically, target device TG1 transmits timestamps for the TOA=t2_tg1 and for the TOD=t3_tg1 to requester device R1 in a first FTM response frame, target device TG2 transmits timestamps for the TOA=t2_tg2 and for the TOD=t3_tg2 to requester device R1 in a second FTM response frame, and target device TG3 transmits timestamps for the TOA=t2_tg3 and for the TOD=t3_tg3 to requester device R1 in a third FTM response frame. Requester device R1 then uses the received timing information to determine RTT values between itself and each of target devices TG1-TG3.

Note that the operation depicted in FIG. 5 requires two fewer frame exchanges than the operation depicted in FIG. 4.

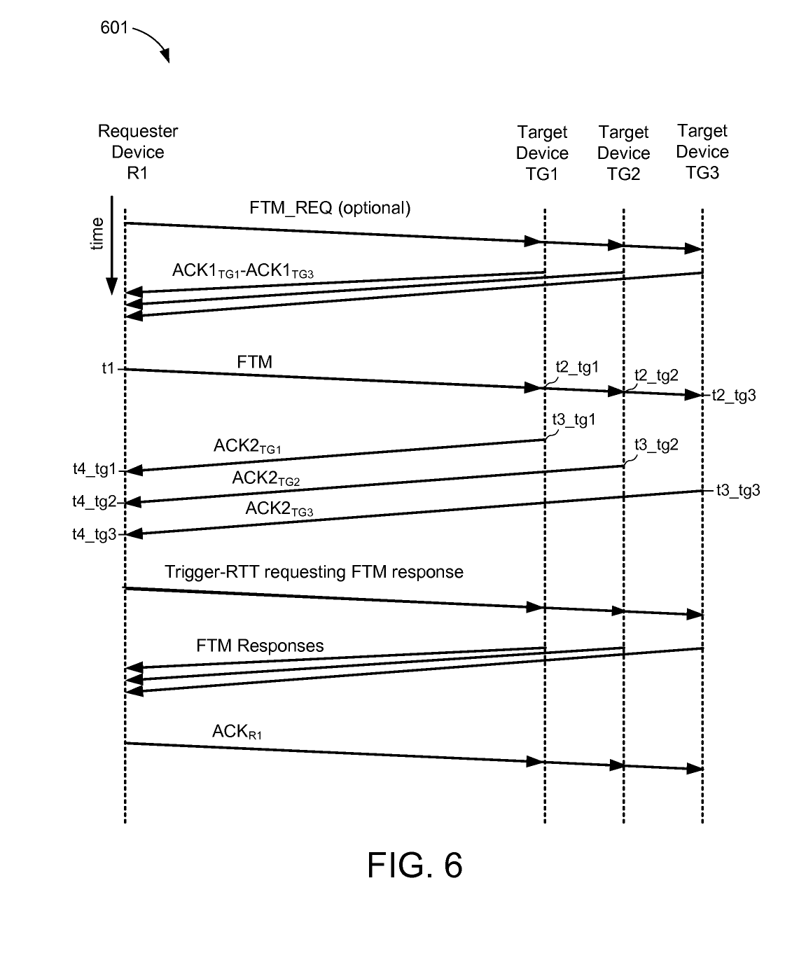

FIG. 6 depicts a sequence diagram 601 of a downlink OFDMA ranging operation using FTM frames in accordance with yet another embodiment. For some implementations, the requester device R1 may allocate a unique set of two or more non-adjacent groups of OFDM sub-carrier frequencies to each of the target devices TG1-TG3, for example, as described above with respect to FIG. 3. Similarly, the requester device R1 may transmit frames to the target devices TG1-TG3 using two or more non-adjacent groups of OFDM sub-carrier frequencies.

As shown in FIG. 6, the operation of FIG. 6 may begin with an FTM_REQ frame transmitted using OFDMA from a requester device R1 to target devices TG1-TG3. The FTM_REQ frame is optional, but if the FTM_REQ frame is transmitted, then the target devices TG1-TG3 may acknowledge receiving the FTM_REQ frame by transmitting a corresponding ACK frame using OFDMA, as defined in the IEEE 802.11ax standards. For example, as depicted in FIG. 6, target device TG1 transmits ACK1_{TG1}, target device TG2 transmits ACK1_{TG2}, and target device TG3 transmits ACK1_{TG3}).

The requester device R1 uses OFDMA to transmit an FTM frame to the target devices TG1-TG3 (at time t1). If an FTM_REQ frame was previously sent from requester device R1 to the target devices TG1-TG3, then the requester device R1 may transmit the FTM frame only to those of target devices TG1-TG3 from which an acknowledgement (ACK) frame was received. The FTM frame depicted in FIG. 6 may indicate the order in which and/or the times at which the target devices TG1-TG3 are to transmit corresponding ACK frames and/or may indicate the inter-frame spacing for each of target devices TG1-TG3. The inter-frame spacing may be a multiple of the SIFS duration plus a multiple of the ACK transit time (TXTIME) plus a function of the propagation times (PPGTIME) between requester device R1 and target device TG1, between requester device R1 and target device TG2, and between requester device R1 and target device TG3. For example, and without limitation, the inter-frame spacing for the three target devices TG1-TG3 may be defined such that:
Target device TG1 transmits an ACK frame after a first time period equal to a SIFS duration;
Target device TG2 transmits an ACK frame after a second time period equal to: a*SIFS+b*TXTIME(ACK)+function(PPGTIME(R1, TG1), PPGTIME(R1, TG2), PPGTIME(R1, TG3));
Target device TG3 transmits an ACK frame after a third time period equal to: c*SIFS+d*TXTTIME(ACK)+function(PPGTIME(R1, TG1), PPGTIME(R1, TG2), PPGTIME(R1, TG3)).
   where a, b, c, and d are integers greater than or equal to one.

In response to receiving the FTM frame, the target devices TG1-TG3 may each determine the TOA of the FTM frame. For example, target device TG1 may capture a timestamp at time t2_tg1 indicative of the TOA of the FTM frame, target device TG2 may capture a timestamp at time t2_tg2 indicative of the TOA of the FTM frame, and target device TG3 may capture a timestamp at time t2_tg3 indicative of the TOA of the FTM frame.

Each of target devices TG1-TG3 responds to receiving the FTM frame by transmitting (to requester device R1) a corresponding ACK frame using OFDMA, as defined in the IEEE 802.11ax standards, and then captures the TOD of the corresponding ACK frame. For example, target device TG1 may capture a timestamp at time t3_tg1 indicative of the TOD of the ACK2_{TG1} frame transmitted to requester device R1, target device TG2 may capture a timestamp at time t3_tg2 indicative of the TOD of the ACK2_{TG2} frame transmitted to requester device R1, and target device TG3 may capture a timestamp at time t3_tg3 indicative of the TOD of the ACK2_{TG3} frame transmitted to requester device R1. The target devices TG1-TG3 may transmit the acknowledgement frames ACK_{TG1}-ACK_{TG3} in the order and/or at the times indicated by the FTM frame, for example, using the maximum supported bandwidth.

The requester device R1 may then determine the TOA of each of the ACK frames received from target devices TG1-TG3. For example, requester device R1 may capture a timestamp at time t4_tg1 indicative of the TOA of ACK2_{TG1}, may capture a timestamp at time t4_tg2 indicative of the TOA of ACK2_{TG2}, and may capture a timestamp at time t4_tg3 indicative of the TOA of ACK2_{TG3}.

Next, requester device R1 may transmit a Trigger-RTT frame to the target devices TG1-TG3 using OFDMA. The Trigger-RTT frame may include one or more fields for sending delay information to the target devices. For at least some embodiments, the delay information may be a delay value indicative of the time between requester device R1 receiving an ACK1 frame and requester device R1 transmitting the FTM frame. The delay value may be expressed as: (TOA of ACK frame−TOD of FTM frame)−standard SIFS. The target devices TG1-TG3 may determine RTT values by using the delay value received in the Trigger-RTT frame. The Trigger-RTT frame may include information to synchronize transmission of the FTM responses from the target devices TG1-TG3 (e.g., as defined in the IEEE 802.11 ax standards), and may include information indicating that each of the target devices TG1-TG3 is to transmit an FTM response frame using OFDMA.

The target devices TG1-TG3 may then transmit FTM response frames (using OFDMA) containing t2 and t3 time stamps (e.g., where the t2 timestamps are indicative of the TOA of the FTM frame at respective target devices TG1-TG3, and the t3 timestamps are indicative of the TOD of the ACK2_{TG1}-ACK2_{TG3} frames from respective target devices TG1-TG3. More specifically, target device TG1 transmits timestamps for the TOA=t2_tg1 and for the TOD=t3_tg1 to requester device R1 in a first FTM response frame, target device TG2 transmits timestamps for the TOA=t2_tg2 and for the TOD=t3_tg2 to requester device R1 in a second FTM response frame, and target device TG3 transmits timestamps for the TOA=t2_tg3 and for the TOD=t3_tg3 to requester device R1 in a third FTM response frame. Requester device R1 then uses the received timing information to determine RTT values between itself and each of target devices TG1-TG3.

Alternatively, requester device R1 may transmit a Trigger frame and an FTM End frame, for example, as depicted in FIG. 4.

The operation depicted in FIG. 6 requires less synchronization between target devices TG1-TG3 for transmitting their respective ACK2_{TG1}-ACK2_{TG3} frames (e.g., as compared with the operation of FIG. 5), and does not require prior knowledge of the coarse propagation delay between the requester device R1 and each of the target devices TG1-TG3. Because the full bandwidth may be used for transmission of each of frames ACK2_{TG1}-ACK2_{TG3}, the requester device R1 may determine the TOAs (t4_tg1, t4_tg2, and t4_tg3) of the frames ACK2_{TG1}-ACK2_{TG3}, respectively, with greater accuracy than the example operations depicted in FIGS. 4 and 5. However, the example operation of FIG. 6 may require the transmission of multiple ACK frames (e.g., compared with the example operations of FIGS. 4 and 5).

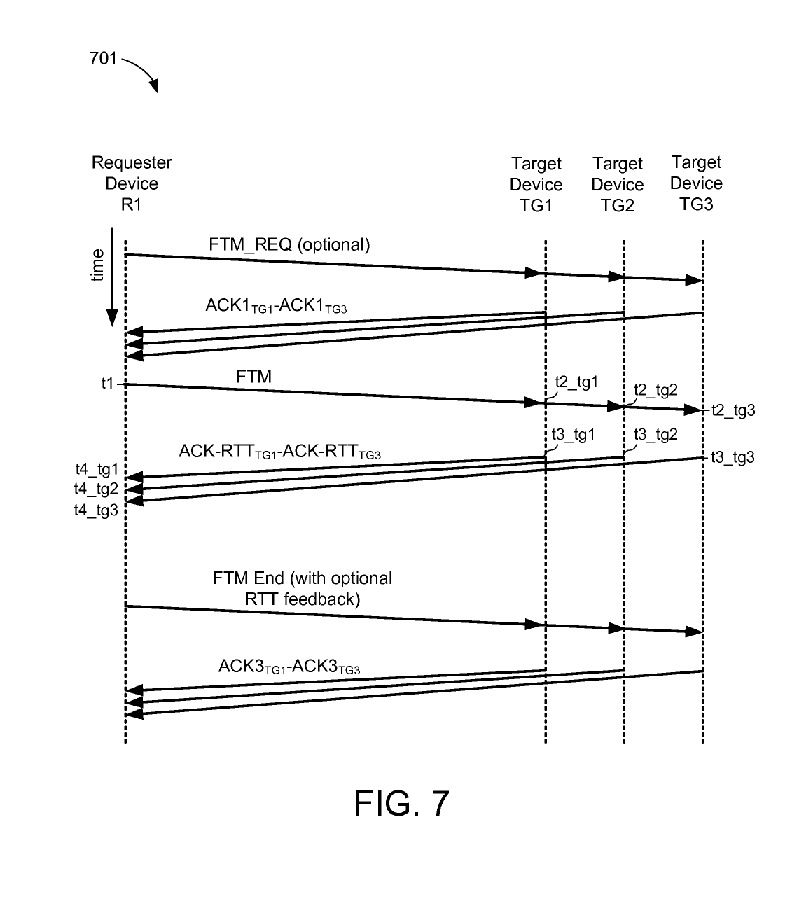

FIG. 7 depicts a sequence diagram 701 of a downlink OFDMA ranging operation using FTM frames in accordance with yet another embodiment. For some implementations, the requester device R1 may allocate a unique set of two or more non-adjacent groups of OFDM sub-carrier frequencies to each of the target devices TG1-TG3, for example, as described above with respect to FIG. 3. Similarly, the requester device R1 may transmit frames to the target devices TG1-TG3 using two or more non-adjacent groups of OFDM sub-carrier frequencies.

As shown in FIG. 7, the operation of FIG. 7 may begin with an FTM_REQ frame transmitted using OFDMA from a requester device R1 to target devices TG1-TG3. The FTM_REQ frame is optional, but if the FTM_REQ frame is transmitted, then the target devices TG1-TG3 may acknowledge receiving the FTM_REQ frame by transmitting a corresponding ACK frame using OFDMA, as defined in the IEEE 802.11ax standards. For example, as depicted in FIG. 7, target device TG1 transmits ACK1_{TG1}, target device TG2 transmits ACK1_{TG2}, and target device TG3 transmits ACK1_{TG3}).

Requester device R1 uses OFDMA to transmit an FTM frame to the target devices TG1-TG3 (at time t1). If an FTM_REQ frame was previously sent from requester device R1 to the target devices TG1-TG3, then the requester device R1 may transmit the FTM frame only to those of the target devices TG1-TG3 from which an acknowledgement (ACK) frame was received. The FTM frame may include a field indicating whether ACK-RTT is supported by requester device R1. In response to receiving the FTM frame, the target devices TG1-TG3 may each determine the TOA of the FTM frame. For example, target device TG1 may capture a timestamp at time t2_tg1 indicative of the TOA of the FTM frame, target device TG2 may capture a timestamp at time t2_tg2 indicative of the TOA of the FTM frame, and target device TG3 may capture a timestamp at time t2_tg3 indicative of the TOA of the FTM frame. If tone interleaving is used, the target devices TG1-TG3 may use the entire preamble of the FTM frame to obtain a full-bandwidth channel estimation. If tone interleaving is not used, but a given target device supports full-bandwidth channel estimation, then the given target device may also use the entire preamble to obtain a full-bandwidth channel estimation. However, if tones are not interleaved, and the given target device does not support full-bandwidth channel estimation, then the given target device may only use the bandwidth allocated to it for TOA estimation.

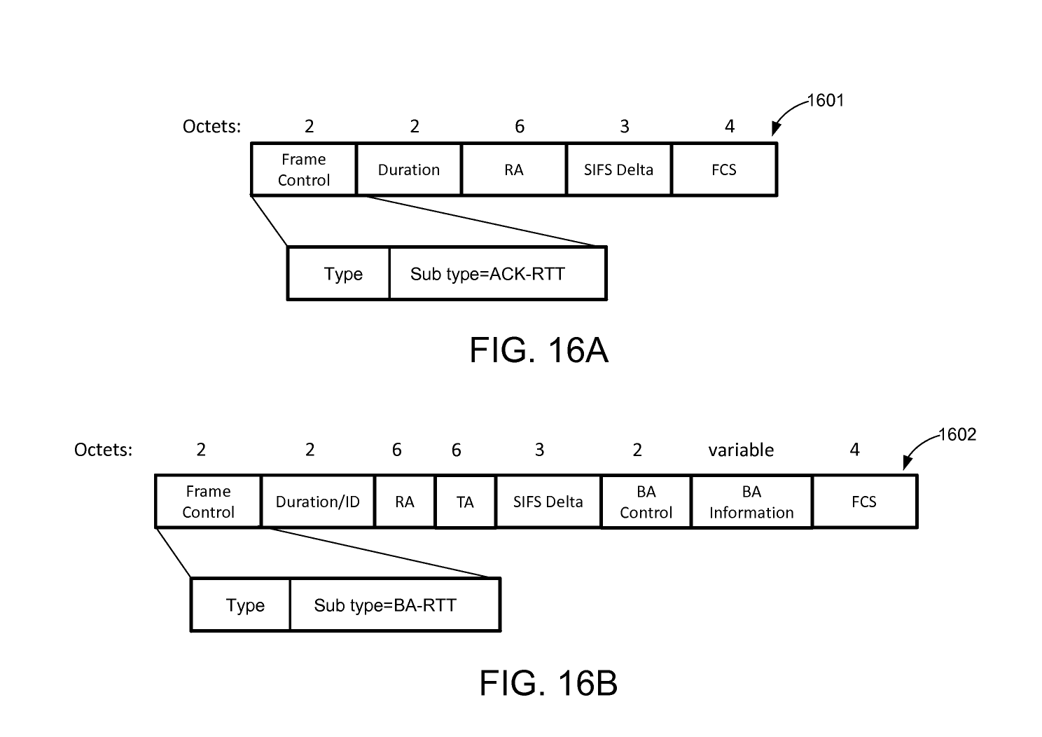

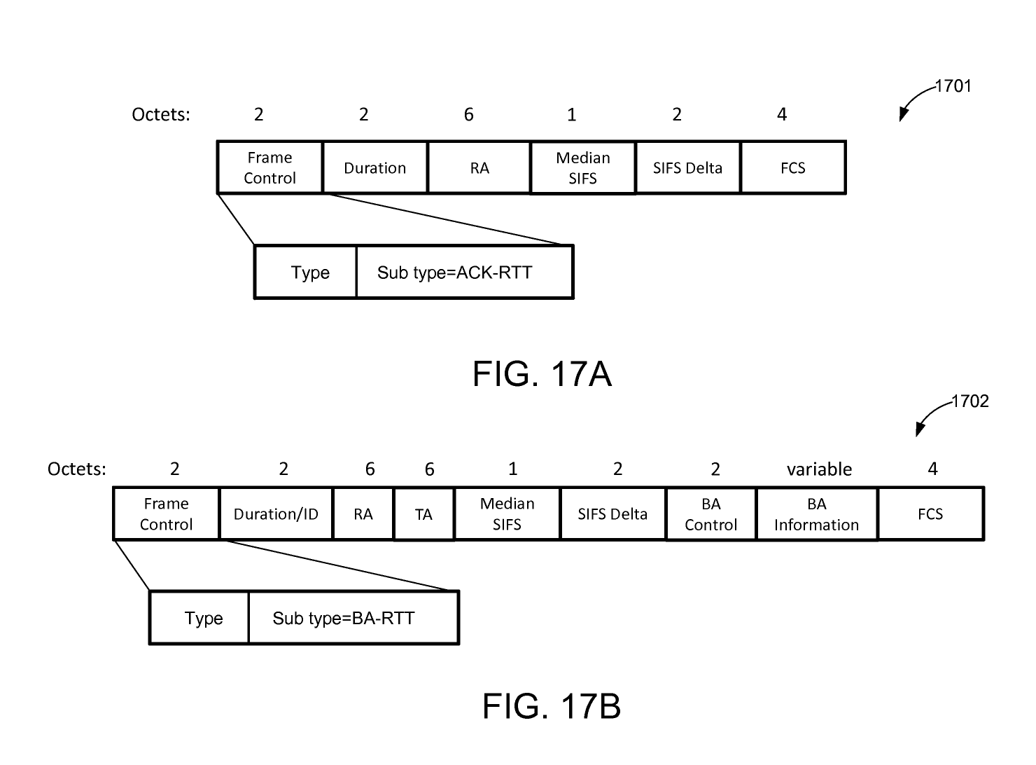

When requester device R1 indicates that it supports ACK-RTT, then target devices TG1-TG3 may acknowledge receiving the FTM frame with ACK-RTT frames instead of ACK frames. The ACK-RTT frames may be transmitted using OFDMA. Each of the ACK-RTT frames may include a field for providing a SIFS delta value from a corresponding one of the target devices TG1-TG3 to the requester device R1. For some embodiments, the SIFS delta value may be expressed as: (TOD of ACK-RTT−TOA of FTM frame)−standard SIFS. Example frame formats for ACK-RTT frames are described below with respect to FIGS. 16A-16B and 17A-17B.

Each of target devices TG1-TG3 responds to receiving the FTM frame by transmitting (to requester device R1) a corresponding ACK-RTT frame using OFDMA, as defined in the IEEE 802.11ax standards, and then captures the TOD of the corresponding ACK-RTT frame. For example, target device TG1 may capture a timestamp at time t3_tg1 indicative of the TOD of the ACK-RTT_{TG1} frame transmitted to requester device R1, target device TG2 may capture a timestamp at time t3_tg2 indicative of the TOD of the ACK-RTT_{TG2} frame transmitted to requester device R1, and target device TG3 may capture a timestamp at time t3_tg3 indicative of the TOD of the ACK-RTT_{TG3} frame transmitted to requester device R1. The FTM frame transmitted by requester device R1 may include information to synchronize transmission of the ACK-RTT frames from the target devices TG1-TG3. For example, FIG. 7 depicts the ACK-RTT_{TG1}-ACK-RTT_{TG3} frames as being transmitted from respective target devices TG1-TG3 at the same time. For other implementations, the FTM frame may include timing information that causes the target devices TG1-TG3 to transmit respective ACK-RTT_{TG1}-ACK-RTT_{TG3} frames at different times, in which case the timestamp values for t3_tg1-t3_tg3 may be different.

The requester device R1 may then determine the TOA of each of the ACK-RTT frames received from target devices TG1-TG3. For example, requester device R1 may capture a timestamp at time t4_tg1 indicative of the TOA of ACK-RTT_{TG1}, may capture a timestamp at time t4_tg2 indicative of the TOA of ACK-RTT_{TG2}, and may capture a timestamp at time t4_tg3 indicative of the TOA of ACK-RTT_{TG3}. Requester device R1 then uses the received timing information to determine RTT values between itself and each of target devices TG1-TG3.

Requester device R1 then transmits an FTM End frame to the target devices TG1-TG3, using OFDMA. The FTM End frame may include one or more fields to transmit the determined RTT values from the requester device R1 to the target devices TG1-TG3.

Note that in the operation of FIG. 7, neither Trigger frames nor FTM response frames are required (e.g., as compared with the operations of FIGS. 4-6).

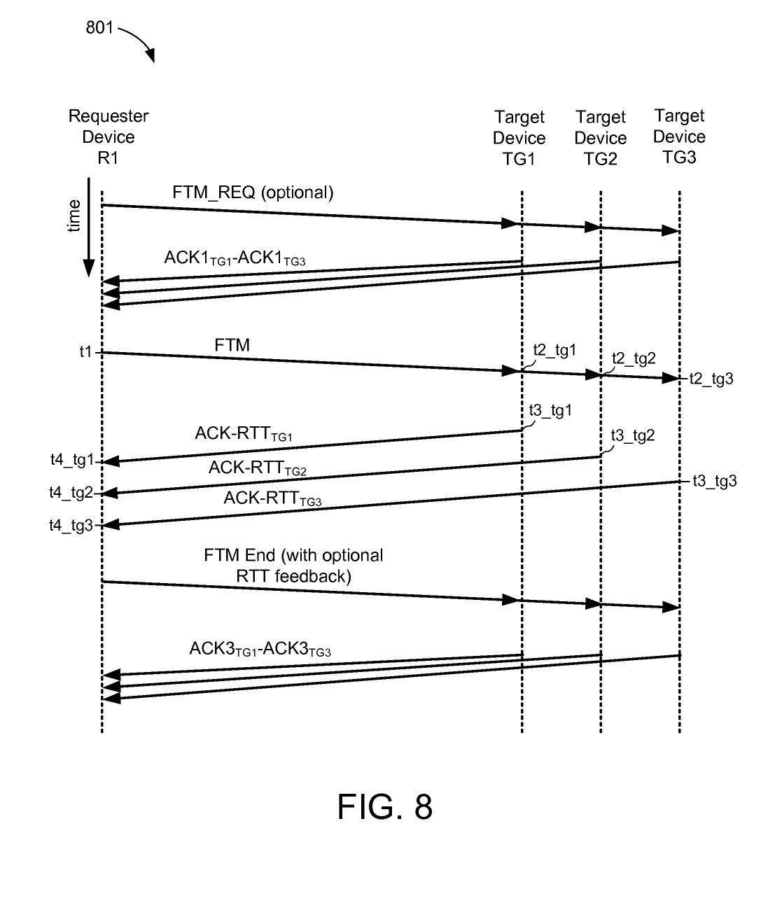

FIG. 8 depicts a sequence diagram 801 of a downlink OFDMA ranging operation using FTM frames in accordance with yet another embodiment. For some implementations, the requester device R1 may allocate a unique set of two or more non-adjacent groups of OFDM sub-carrier frequencies to each of the target devices TG1-TG3, for example, as described above with respect to FIG. 3. Similarly, the requester device R1 may transmit frames to the target devices TG1-TG3 using two or more non-adjacent groups of OFDM sub-carrier frequencies.

As shown in FIG. 8, the operation may begin with an FTM_REQ frame transmitted using OFDMA from requester device R1 to target devices TG1-TG3. The FTM_REQ frame is optional, but if the FTM_REQ frame is transmitted, then the target devices TG1-TG3 may acknowledge receiving the FTM_REQ frame by transmitting a corresponding ACK frame using OFDMA, as defined in the IEEE 802.11ax standards. For example, as depicted in FIG. 4, target device TG1 transmits ACK1_{TG1}, target device TG2 transmits ACK1_{TG2}, and target device TG3 transmits ACK1_{TG3}).

The requester device R1 uses OFDMA to transmit an FTM frame to the target devices TG1-TG3 (at time t1). If an FTM_REQ frame was previously sent from requester device R1 to the target devices TG1-TG3, then the requester device R1 may transmit the FTM frame only to those of target devices TG1-TG3 from which an acknowledgement (ACK) frame was received. The FTM frame may include a field indicating whether ACK-RTT is supported by requester device R1. The FTM frame may also indicate the order in which and/or times at which the target devices TG1-TG3 are to transmit an ACK or ACK-RTT frame and/or may indicate the inter-frame spacing for each of target devices TG1-TG3. The inter-frame spacing may be a multiple of the SIFS duration plus a multiple of the ACK/ACK-RTT transit time (TXTIME) plus a function of the propagation times (PPGTIME) between requester device R1 and target device TG1, between requester device R1 and target device TG2, and between requester device R1 and target device TG3. For example, and without limitation, the inter-frame spacing for the three target devices TG1-TG3 may be defined such that:
Target device TG1 transmits an ACK or ACK-RTT frame after a first time period equal to a SIFS duration;
Target device TG2 transmits an ACK or ACK-RTT frame after a second time period equal to: a*SIFS+b*TXTIME(ACK/ACK-RTT)+function(PPGTIME(R1, TG1), PPGTIME(R1, TG2), PPGTIME(R1, TG3));
Target device TG3 transmits an ACK or ACK-RTT frame after a third time period equal to: c*SIFS+d*TXTTIME(ACK/ACK-RTT)+function(PPGTIME(R1, TG1), PPGTIME(R1, TG2), PPGTIME(R1, TG3)),
   where a, b, c, and d are integers greater than or equal to one.

In response to receiving the FTM frame, the target devices TG1-TG3 may each determine the TOA of the FTM frame. For example, target device TG1 may capture a timestamp at time t2_tg1 indicative of the TOA of the FTM frame, target device TG2 may capture a timestamp at time t2_tg2 indicative of the TOA of the FTM frame, and target device TG3 may capture a timestamp at time t2_tg3 indicative of the TOA of the FTM frame.

When requester device R1 indicates that it supports ACK-RTT, then target devices TG1-TG3 may respond with ACK-RTT frames instead of ACK frames. The ACK-RTT frames may be transmitted using OFDMA. Thus, the target devices TG1-TG3 may then transmit ACK frames in the order and/or at the times indicated in the FTM frame, using the maximum supported bandwidth. More specifically, for the example of FIG. 8, each of target devices TG1-TG3 responds to receiving the FTM frame by transmitting (to requester device R1) a corresponding ACK-RTT frame using OFDMA, as defined in the IEEE 802.11ax standards, and then captures the TOD of the corresponding ACK-RTT frame. For example, target device TG1 may capture a timestamp at time t3_tg1 indicative of the TOD of the ACK-RTT_{TG1} frame transmitted to requester device R1, target device TG2 may capture a timestamp at time t3_tg2 indicative of the TOD of the ACK-RTT_{TG2} frame transmitted to requester device R1, and target device TG3 may capture a timestamp at time t3_tg3 indicative of the TOD of the ACK-RTT_{TG3} frame transmitted to requester device R1.

The requester device R1 may then determine the TOA of each of the ACK-RTT frames received from the respective target devices TG1-TG3. For example, requester device R1 may capture a timestamp at time t4_tg1 indicative of the TOA of ACK-RTT_{TG1}, may capture a timestamp at time t4_tg2 indicative of the TOA of ACK-RTT_{TG2}, and may capture a timestamp at time t4_tg3 indicative of the TOA of ACK-RTT_{TG3}.

Requester device R1 then uses the received timing information to determine RTT values between itself and each of target devices TG1-TG3. Requester device R1 may then transmit an FTM End frame to the target devices TG1-TG3, using OFDMA. The FTM End frame may include one or more fields containing the determined RTT values (e.g., thereby providing the determined RTT values to the target devices TG1-TG3).

Note that in the operation of FIG. 8, neither Trigger frames nor FTM response frames are required. The operation depicted in FIG. 8 also requires less synchronization for the ACK-RTT frames, and does not require prior knowledge of the coarse propagation delay between devices (e.g., as compared to the operations of FIGS. 4-7). Because the full bandwidth may be used for each ACK-RTT frame, the requester device R1 may determine the TOAs of the ACK-RTT_{TG1}-ACK-RTT_{TG3} frames, respectively, with greater accuracy than the example operation depicted in FIG. 7. Note that for the operation of FIG. 8, multiple ACK-RTT frames are required (e.g., rather than just one ACK-RTT frame).

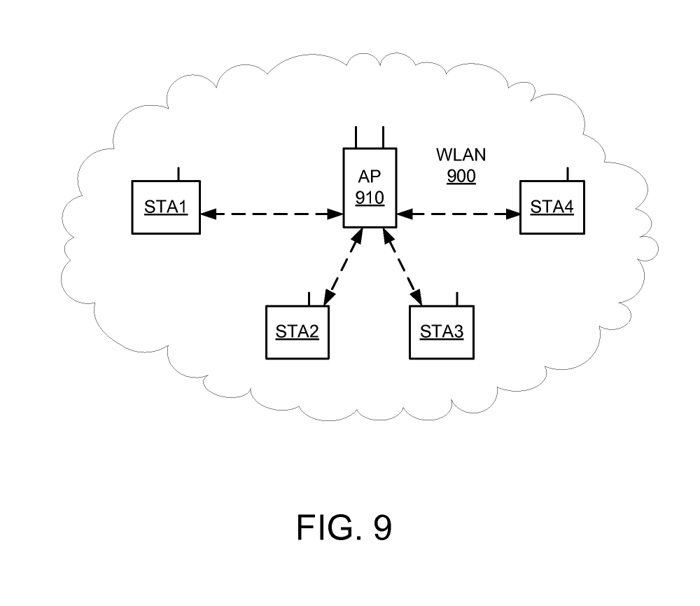

FIG. 9 is a block diagram of a wireless local area network (WLAN) 900 within which the example embodiments may be implemented. WLAN 900 is shown to include an access point (AP) 910 and a number of mobile stations STA1-STA4. The WLAN 900, which is formed by AP 910, may operate according to the IEEE 802.11 family of standards (or according to other suitable wireless protocols). Although only one AP 910 is shown in FIG. 9 for simplicity, WLAN 900 may be formed by any number of access points. Similarly, although four stations STA1-STA4 are shown in FIG. 9, WLAN 900 and/or AP 910 may be associated with other numbers of stations.

The AP 910 and stations STA1-STA4 are each assigned a unique media access control (MAC) address that may be programmed therein by, for example, the manufacturer of the device. For some embodiments, the WLAN 900 may correspond to a multiple-input multiple-output (MIMO) wireless network. Further, although the WLAN 900 is depicted in FIG. 9 as an infrastructure BSS, for other example embodiments, WLAN 900 may be an IBSS, an ad-hoc network, or a peer-to-peer (P2P) network (e.g., operating according to the Wi-Fi Direct protocols).

Each of stations STA1-STA4 may be any suitable Wi-Fi enabled wireless device including, for example, a cell phone, personal digital assistant (PDA), tablet device, laptop computer, or the like. Each station STA may also be referred to as a user equipment (UE), a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. For at least some embodiments, each of stations STA1-STA4 may include one or more transceivers, one or more processing resources (e.g., processors and/or ASICs), one or more memory resources, and a power source (e.g., a battery). The memory resources may include a non-transitory computer-readable medium (e.g., one or more nonvolatile memory elements, such as EPROM, EEPROM, Flash memory, a hard drive, etc.) that stores instructions for performing operations described below with respect to FIGS. 4-8 and 11-15.

The AP 910 may be any suitable device that allows one or more wireless devices to connect to a network (e.g., a local area network (LAN), wide area network (WAN), metropolitan area network (MAN), and/or the Internet) via AP 910 using Wi-Fi, Bluetooth, or any other suitable wireless communication standards. For at least one embodiment, AP 910 may include one or more transceivers, one or more processing resources (e.g., processors and/or ASICs), one or more memory resources, and a power source. The memory resources may include a non-transitory computer-readable medium (e.g., one or more nonvolatile memory elements, such as EPROM, EEPROM, Flash memory, a hard drive, etc.) that stores instructions for performing operations described below with respect to FIGS. 4-8 and 11-15.

For the stations STA1-STA4 and/or AP 910, the one or more transceivers may include Wi-Fi transceivers, Bluetooth transceivers, cellular transceivers, and/or other suitable radio frequency (RF) transceivers (not shown for simplicity) to transmit and receive wireless communication signals. Each transceiver may communicate with other wireless devices in distinct operating frequency bands and/or using distinct communication protocols. For example, the Wi-Fi transceiver may communicate within a 2.4 GHz frequency band and/or within a 5 GHz frequency band in accordance with the IEEE 802.11 specification. The cellular transceiver may communicate within various RF frequency bands in accordance with a 4G Long Term Evolution (LTE) protocol described by the 3rd Generation Partnership Project (3GPP) (e.g., between approximately 700 MHz and approximately 3.9 GHz) and/or in accordance with other cellular protocols (e.g., a Global System for Mobile (GSM) communications protocol). In other embodiments, the transceivers included within the STA may be any technically feasible transceiver such as a ZigBee transceiver described by a specification from the ZigBee specification, a WiGig transceiver, and/or a HomePlug transceiver described a specification from the HomePlug Alliance.

For example embodiments described herein, each of the stations STA1-STA4 and/or AP 910 may include radio frequency (RF) ranging circuitry (e.g., formed using well-known software modules, hardware components, and/or a suitable combination thereof) that may be used to estimate the RTT and distance between itself and one or more other Wi-Fi enabled devices using ranging techniques described herein.

For at least some embodiments, ranging operations described herein may be performed without using the AP 910, for example, by having a number of the stations operating in an ad-hoc or peer-to-peer mode, thereby allowing the stations STA1-STA4 to perform RTT measurements even when outside the reception range of AP 910 or a visible WLAN (or other wireless network). In addition, ranging operations described herein may be performed between two APs that are in wireless range of each other.

Requester device R1 and target devices TG1-TG3 discussed above and depicted in the sequence diagrams of FIGS. 4-8 may each be one of AP 910 or STA1-STA4 of FIG. 9.

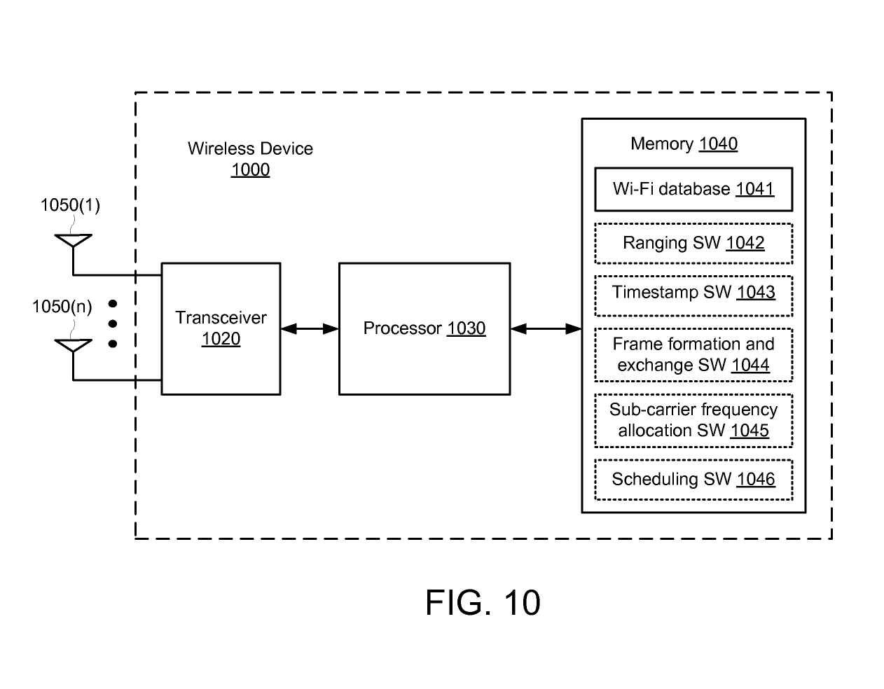

FIG. 10 shows a wireless device 1000 that may be one embodiment of the stations STA1-STA4 and/or AP 910 of FIG. 9. The wireless device 1000 may include a transceiver 1020, a processor 1030, a memory 1040, and a number of antennas 1050(1)-1050(n). The transceiver 1020 may be coupled to antennas 1050(1)-1050(n), either directly or through an antenna selection circuit (not shown for simplicity). The transceiver 1020 may be used to transmit signals to and receive signals from access points, mobile stations, and/or other suitable wireless devices. Although not shown in FIG. 10 for simplicity, the transceiver 1020 may include any number of transmit chains to process and transmit signals to other wireless devices via antennas 1050(1)-1050(n), and may include any number of receive chains to process signals received from antennas 1050(1)-1050(n). Thus, for example embodiments, the wireless device 1000 may be configured for MIMO operations. The MIMO operations may include single-user MIMO (SU-MIMO) operations and multi-user MIMO (MU-MIMO) operations.

Memory 1040 may include a Wi-Fi database 1041 that may store location data, configuration information, data rates, MAC addresses, and other suitable information (e.g., profile information) for a number of access points and/or stations. For one example, the profile information for a particular AP may include information including, for example, the AP's service set identification (SSID), MAC address, channel information, received signal strength indicator (RSSI) values, goodput values, channel state information (CSI), supported data rates, connection history with wireless device 1000, a trustworthiness value of the AP (e.g., indicating a level of confidence about the AP's location, etc.), previous ranging operations, and any other suitable information pertaining to or describing the operation of the AP. For another example, the profile information for a particular STA may include information including, for example, its MAC address, previous ranging operations, supported data rates, connection history with wireless device 1000, and any other suitable information pertaining to or describing the operation of the STA.

Memory 1040 may also include a non-transitory computer-readable medium (e.g., one or more nonvolatile memory elements, such as EPROM, EEPROM, Flash memory, a hard drive, and so on) that may store the following software (SW) modules:
a ranging SW module 1042 to determine RTT values and/or the distance between the device 1000 and another device (e.g., as described for one or more operations of FIGS. 4-8 and 11-15);
a timestamp SW module 1043 to capture timestamps (e.g., frame TOD and/or frame TOA information) and to determine actual SIFS durations associated with frame exchanges of device 1000 (e.g., as described for one or more operations of FIGS. 4-8 and 11-15);
a frame formation and exchange SW module 1044 to create, transmit, and/or receive frames or packets (e.g., control frames, data frames, and management frames) and/or to embed SIFS durations into selected frames or packets (e.g., as described for one or more operations of FIGS. 4-8 and 11-15);
a sub-carrier frequency allocation SW module 1045 to allocate a unique set of two or more non-adjacent groups of OFDM sub-carrier frequencies to each of the target devices TG1-TG3 (e.g., as described for one or more operations of FIGS. 4-8 and 11-15); and
a scheduling SW module 1046 to indicate the time(s) at which the target devices TG1-TG3 are to transmit ACK frames and/or to indicate an order in which the target devices TG1-TG3 are to transmit ACK frames (e.g., as described for one or more operations of FIGS. 4-8 and 11-15).
   Each software module includes instructions that, when executed by processor 1030, cause the device 1000 to perform the corresponding functions. The non-transitory computer-readable medium of memory 1040 thus includes instructions for performing all or a portion of the operations of FIGS. 4-8.

Processor 1030, which is coupled to transceiver 1020 and memory 1040, may be any one or more suitable processors capable of executing scripts or instructions of one or more software programs stored in device 1000 (e.g., within memory 1040). For example, processor 1030 may execute ranging SW module 1042, timestamp SW module 1043, and frame formation and exchange SW module 1044. The ranging SW module 1042 may be executed by processor 1030 to determine the RTT and/or distance between device 1000 and another Wi-Fi enabled device using RF ranging operations. The timestamp SW module 1043 may be executed by processor 1030 to capture timestamps (e.g., frame TOD and/or frame TOA information) and to determine actual SIFS durations associated with frame exchanges of device 1000. The frame formation and exchange SW module 1044 may be executed by processor 1030 to create, transmit, and/or receive frames or packets (e.g., control frames, data frames, and management frames) and to embed SIFS durations into selected frames or packets. The sub-carrier frequency allocation SW module 1045 may be executed by processor 1030 to allocate a unique set of two or more non-adjacent groups of OFDM sub-carrier frequencies to each of the target devices TG1-TG3. The scheduling SW module 1046 may be executed by processor 1030 to indicate the time(s) at which the target devices TG1-TG3 are to transmit ACK frames and/or to indicate an order in which the target devices TG1-TG3 are to transmit ACK frames.

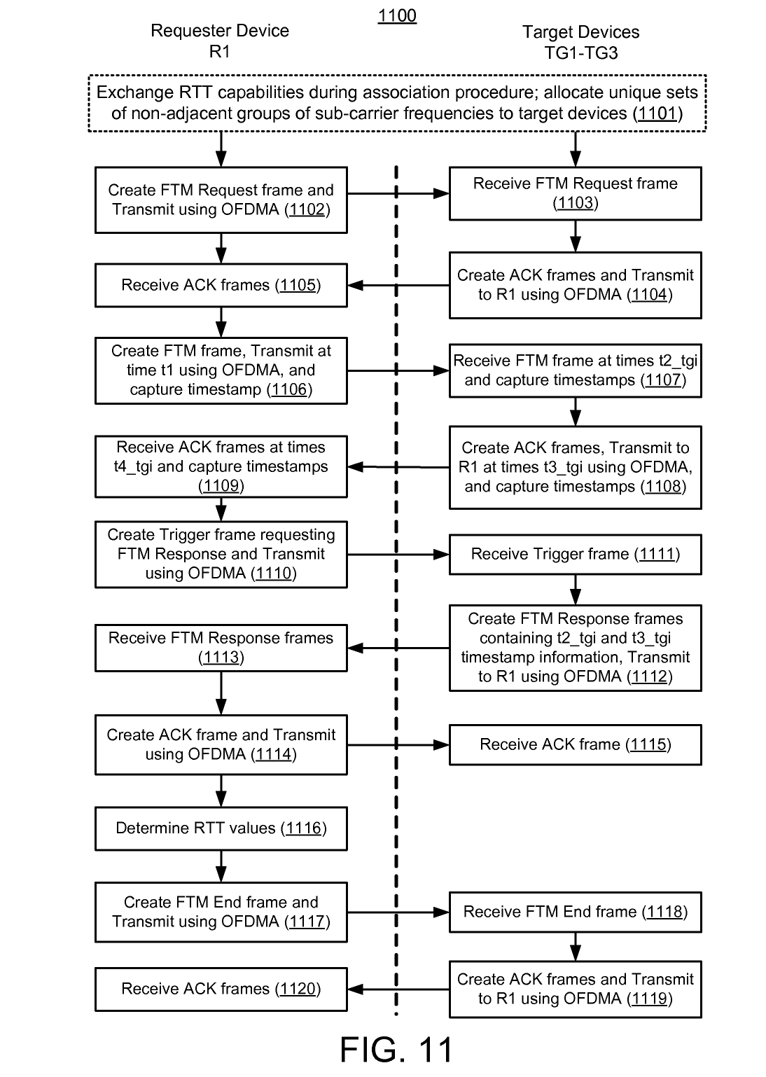

FIG. 11 shows an illustrative flowchart 1100 depicting the ranging operation of FIG. 4 in accordance with example embodiments. First, the requester device R1 and the target devices TG1-TG3 may exchange RTT capabilities during association (or after association using any suitable frames), and the requester device R1 (or another suitable device) may allocate a unique set of two or more non-adjacent groups of OFDM sub-carrier frequencies to each of the target devices TG1-TG3 (1101). The requester device R1 may create and transmit an FTM_REQ frame using OFDMA to target devices TG1-TG3 (1102). Each of target devices TG1-TG3 receives the FTM_REQ frame (1103), and then creates and transmits a corresponding ACK frame to requester device R1 (1104). The requester device R1 receives the ACK frames from target devices TG1-TG3 (1105).

Referring also to FIG. 4, at time t1, requester device R1 uses OFDMA to transmit an FTM frame to the target devices TG1-TG3 (1106). Each of the target devices TG1-TG3 receives the FTM frame and captures the respective TOA information of the FTM frame (e.g., as timestamps t2_tg1, t2_tg2, and t2_tg3, respectively) (1107).

Each of target devices TG1-TG3 responds to receiving the FTM frame by creating and transmitting a corresponding ACK frame to the requester device R1, and captures the TOD of the corresponding ACK frame (e.g., as timestamps t3_tg1, t3_tg2, and t3_tg3, respectively) (1108). The requester device R1 receives the ACK frames transmitted from target devices TG1-TG3, and captures the TOA timestamps of the ACK frames (e.g., as timestamps t4_tg1, t4_tg2, and t4_tg3, respectively) (1109).

Requester device R1 transmits a Trigger frame (e.g., as defined in the IEEE 802.11ax standards) to the target devices TG1-TG3, using OFDMA (1110). The Trigger frame may indicate that each of the target devices TG1-TG3 is to transmit an FTM response frame using OFDMA. Each of the target devices TG1-TG3 receives the Trigger frame (1111), and then creates and transmits a corresponding FTM response frame (using OFDMA) containing the t2 and t3 timestamps (e.g., indicating the TOA of the FTM frame and the TOD of the corresponding ACK frame, respectively) (1112).

Requester device R1 receives the FTM response frames from the target devices TG1-TG3 (1113), and then creates and transmits an ACK frame (using OFDMA) to the target devices TG1-TG3 (1114). Target devices TG1-TG3 receive the ACK frame (1115).

Requester device R1 then uses the received timing information to determine RTT values between itself and each of target devices TG1-TG3 (1116). Requester device R1 may then create and transmit (using OFDMA) an FTM End frame to the target devices TG1-TG3 (1117). The FTM End frame may include the determined RTT values. Target devices TG1-TG3 receive the FTM End frame (1118), and respond by transmitting ACK frames to the requester device R1 (1119). The requester device R1 receives the ACK frames (1120).

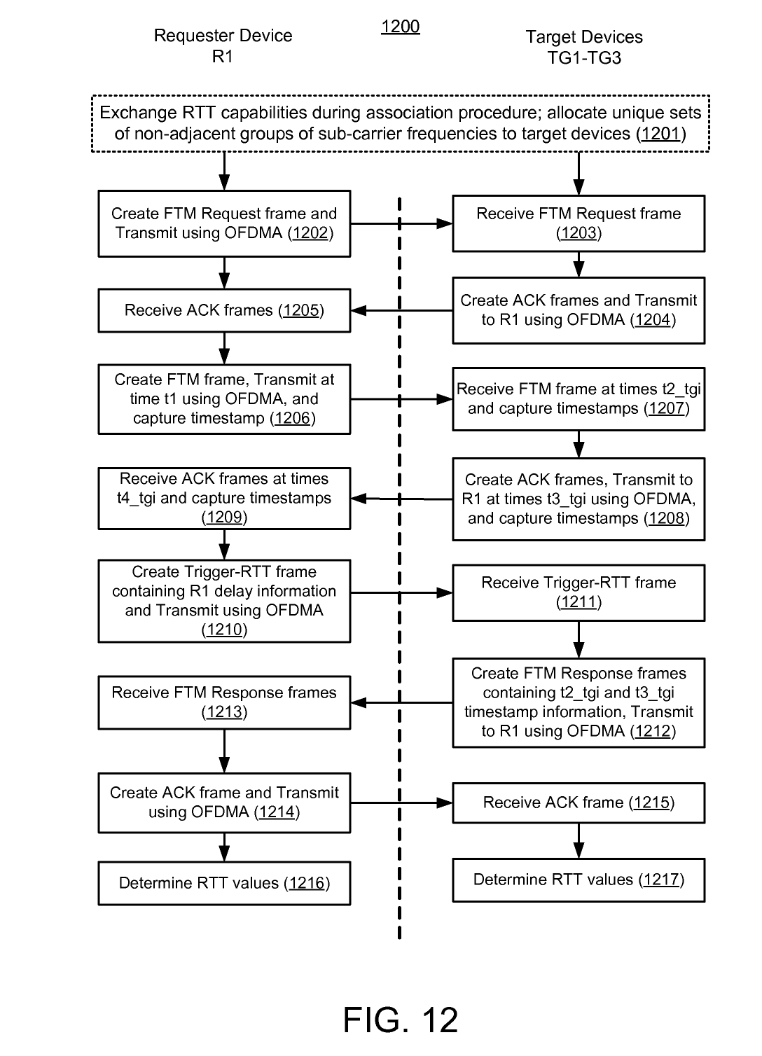

FIG. 12 shows an illustrative flowchart 1200 depicting the ranging operation of FIG. 5 in accordance with example embodiments. First, the requester device R1 and the target devices TG1-TG3 may exchange RTT capabilities during association (or after association using any suitable frames), and the requester device R1 (or another suitable device) may allocate a unique set of two or more non-adjacent groups of OFDM sub-carrier frequencies to each of the target devices TG1-TG3 (1201). The requester device R1 may create and transmit an FTM_REQ frame using OFDMA to target devices TG1-TG3 (1202). Each of target devices TG1-TG3 receives the FTM_REQ frame (1203), and then creates and transmits an ACK frame to requester device R1 (1204). The requester device R1 receives the ACK frames from target devices TG1-TG3 (1205).

Referring also to FIG. 5, at time t1, requester device R1 uses OFDMA to transmit an FTM frame to the target devices TG1-TG3 (1206). Each of the target devices TG1-TG3 receives the FTM frame and captures the respective TOA information (e.g., as timestamps t2_tg1, t2_tg2, and t2_tg3, respectively) (1207).

Each of target devices TG1-TG3 responds to receiving the FTM frame by creating and transmitting a corresponding ACK frame to the requester device R1, and captures the TOD of the corresponding ACK frame (e.g., as timestamps t3_tg1, t3_tg2, and t3_tg3, respectively) (1208). The requester device R1 receives the ACK frames transmitted from target devices TG1-TG3, and captures the TOA timestamps of the ACK frames (e.g., as timestamps t4_tg1, t4_tg2, and t4_tg3, respectively) (1209).

Requester device R1 creates and transmits a Trigger-RTT frame (e.g., as defined in the IEEE 802.11ax standards) to the target devices TG1-TG3, using OFDMA (1210). The Trigger-RTT frame may include one or more fields for sending its delay information (e.g., its turn-around time) to the target devices, and may also include information to synchronize the FTM responses transmitted by the target devices TG1-TG3 (e.g., as defined in the IEEE 802.11 ax standards). Each of the target devices TG1-TG3 receives the Trigger-RTT frame (1211), and then creates and transmits a corresponding FTM response frame (using OFDMA) containing the t2 and t3 timestamps (e.g., indicating the TOA of the FTM frame and the TOD of the corresponding ACK frame, respectively) (1212).

Requester device R1 receives the FTM response frames from the target devices TG1-TG3 (1213), and then creates and transmits an ACK frame (using OFDMA) to the target devices TG1-TG3 (1214). Target devices TG1-TG3 receive the ACK frame (1215).

Requester device R1 then uses the received timing information to determine RTT values between itself and each of target devices TG1-TG3 (1216). Each of the target devices TG1-TG3 may use the delay information of requester device R1, as included in the Trigger-RTT frame, to determine an RTT value between itself and the requester device R1 (1217).

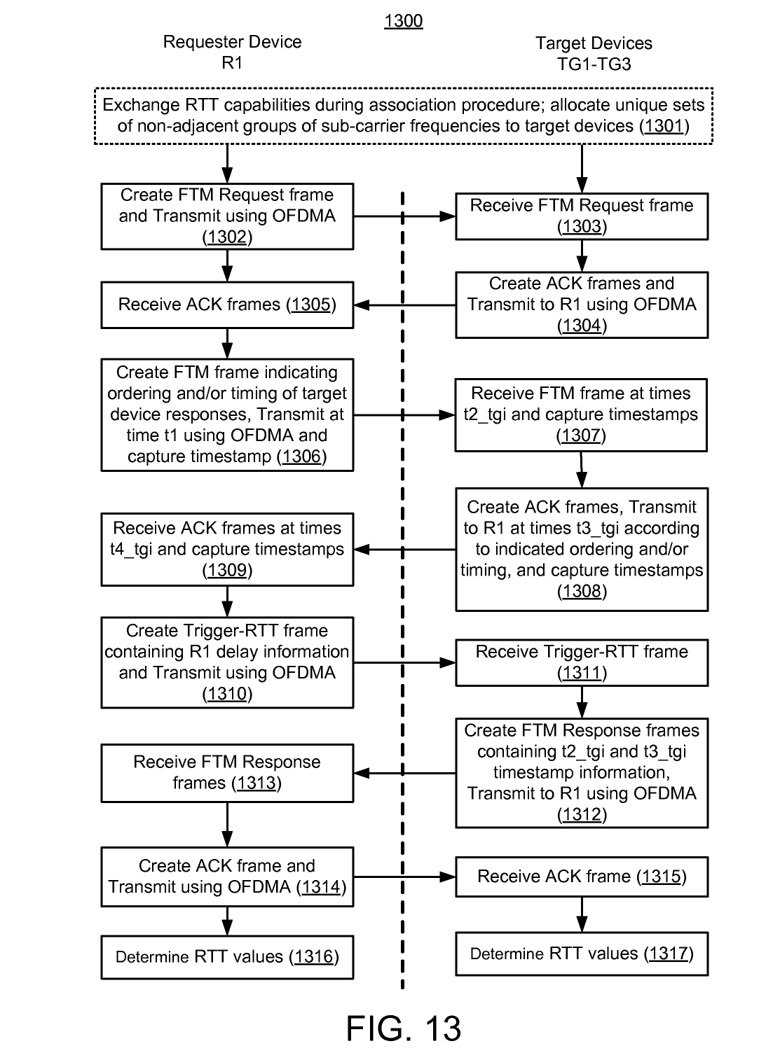

FIG. 13 shows an illustrative flowchart 1300 depicting the ranging operation of FIG. 6 in accordance with example embodiments. First, the requester device R1 and the target devices TG1-TG3 may exchange RTT capabilities during association (or after association using any suitable frames), and the requester device R1 (or another suitable device) may allocate a unique set of two or more non-adjacent groups of OFDM sub-carrier frequencies to each of the target devices TG1-TG3 (1301). The requester device R1 may create and transmit an FTM_REQ frame using OFDMA to target devices TG1-TG3 (1302). Each of target devices TG1-TG3 receives the FTM_REQ frame (1303), and then creates and transmits an ACK frame to requester device R1 (1304). The requester device R1 receives the ACK frames (1305).

Referring also to FIG. 6, at time t1, requester device R1 uses OFDMA to transmit an FTM frame to the target devices TG1-TG3 (1306). The FTM frame may indicate the order in which and/or the times at which the target devices are to transmit corresponding ACK frames and/or may indicate the inter-frame spacing for each of target devices TG1-TG3. Each of the target devices TG1-TG3 receives the FTM frame, and captures the respective TOA information (e.g., as timestamps t2_tg1, t2_tg2, and t2_tg3, respectively) (1307).

Each of target devices TG1-TG3 responds to receiving the FTM frame by creating and transmitting a corresponding ACK frame to the requester device R1 using the full bandwidth, for example, according to the ordering and timing information included in the FTM frame, and captures the TOD of the corresponding ACK frame (e.g., as timestamps t3_tg1, t3_tg2, and t3_tg3, respectively) (1308). The requester device R1 receives the ACK frames transmitted from target devices TG1-TG3, and captures the TOA timestamps of the ACK frames (e.g., as timestamps t4_tg1, t4_tg2, and t4_tg3, respectively) (1309).

Requester device R1 creates and transmits a Trigger-RTT frame (e.g., as defined in the IEEE 802.11ax standards) to the target devices TG1-TG3, using OFDMA (1310). The Trigger-RTT frame may include one or more fields for sending delay information of requester device R1 to the target devices TG1-TG3, and may also include information to synchronize the FTM responses transmitted by the target devices TG1-TG3 (e.g., as defined in the IEEE 802.11 ax standards). Each of the target devices TG1-TG3 receives the Trigger-RTT frame (1311), and then creates and transmits a corresponding FTM response frame (using OFDMA) containing the t2 and t3 timestamps (e.g., indicating the TOA of the FTM frame and the TOD of the corresponding ACK frame, respectively) (1312).

Requester device R1 receives the FTM response frames from the target devices TG1-TG3 (1313), and then creates and transmits an ACK frame (using OFDMA) to the target devices TG1-TG3 (1314). Target devices TG1-TG3 receive the ACK frame (1315).

Requester device R1 then uses the received timing information to determine RTT values between itself and each of target devices TG1-TG3 (1316). Each of the target devices TG1-TG3 may use the delay information of requester device R1, as included in the Trigger-RTT frame, to determine an RTT value between itself and the requester device R1 (1317).

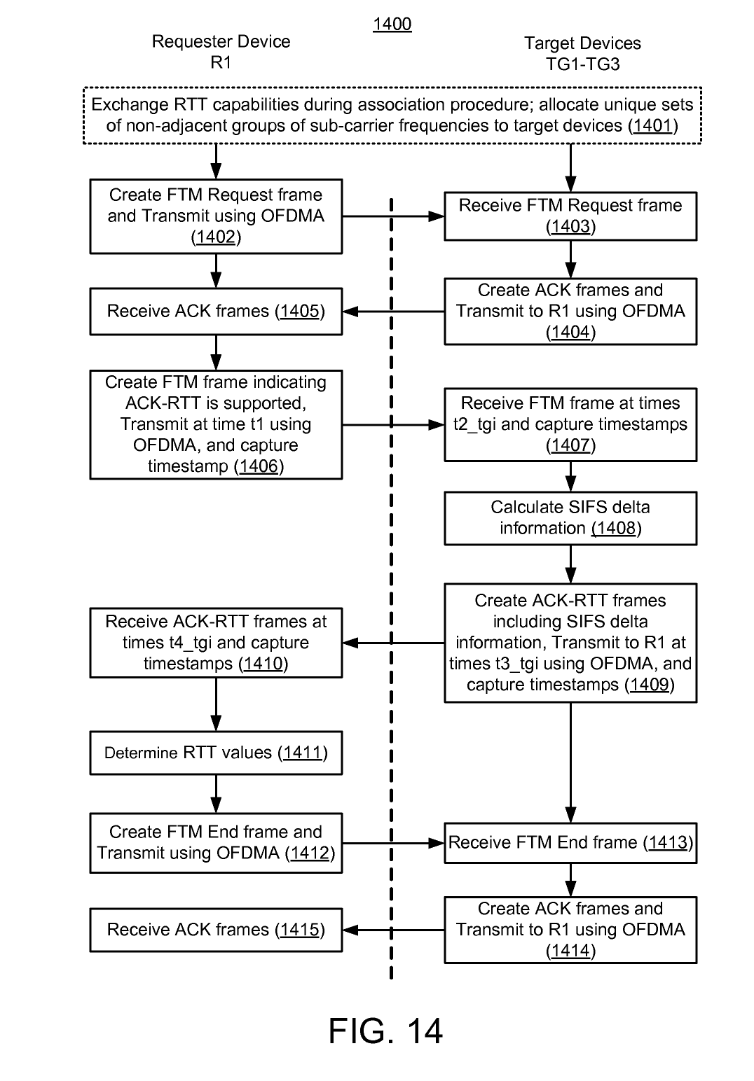

FIG. 14 shows an illustrative flowchart 1400 depicting the ranging operation of FIG. 7 in accordance with example embodiments. First, the requester device R1 and the target devices TG1-TG3 may exchange RTT capabilities during association (or after association using any suitable frames), and the requester device R1 (or another suitable device) may allocate a unique set of two or more non-adjacent groups of OFDM sub-carrier frequencies to each of the target devices TG1-TG3 (1401). The requester device R1 may create and transmit an FTM_REQ frame using OFDMA to target devices TG1-TG3 (1402). Each of target devices TG1-TG3 receives the FTM_REQ frame (1403), and then creates and transmits a corresponding ACK frame to requester device R1 (1404). The requester device R1 receives the ACK frames from target devices TG1-TG3 (1405).

Referring also to FIG. 7, at time t1, requester device R1 uses OFDMA to transmit an FTM frame to the target devices TG1-TG3 (1406). The FTM frame may indicate that ACK-RTT frames are supported. Each of the target devices TG1-TG3 receives the FTM frame and captures the respective TOA information (e.g., as timestamps t2_tg1, t2_tg2, and t2_tg3, respectively) (1407). Each of target devices TG1-TG3 may calculate SIFS delta information (1408).

Each of target devices TG1-TG3 responds to receiving the FTM frame by creating and transmitting a corresponding ACK-RTT frame to the requester device R1 using OFDMA, and captures the TOD of the corresponding ACK-RTT frame (e.g., as timestamps t3_tg1, t3_tg2, and t3_tg3, respectively) (1409). Each of the ACK-RTT frames may include the SIFS delta information for a corresponding one of the target devices TG1-TG3. The requester device R1 receives the ACK-RTT frames and captures the timestamps of the ACK-RTT frames (e.g., as timestamps t4_tg1, t4_tg2, and t4_tg3, respectively) (1410).

Requester device R1 then uses the received timing information (e.g., the SIFS delta information for target devices TG1-TG3) to determine RTT values between itself and each of target devices TG1-TG3 (1411). Requester device R1 may then create and transmit (using OFDMA) an FTM End frame to the target devices TG1-TG3 (1412). The FTM End frame may include the determined RTT values. Target devices TG1-TG3 receive the FTM End frame (1413), and respond by transmitting ACK frames to the requester device R1 (1414). The requester device R1 receives the ACK frames (1415).

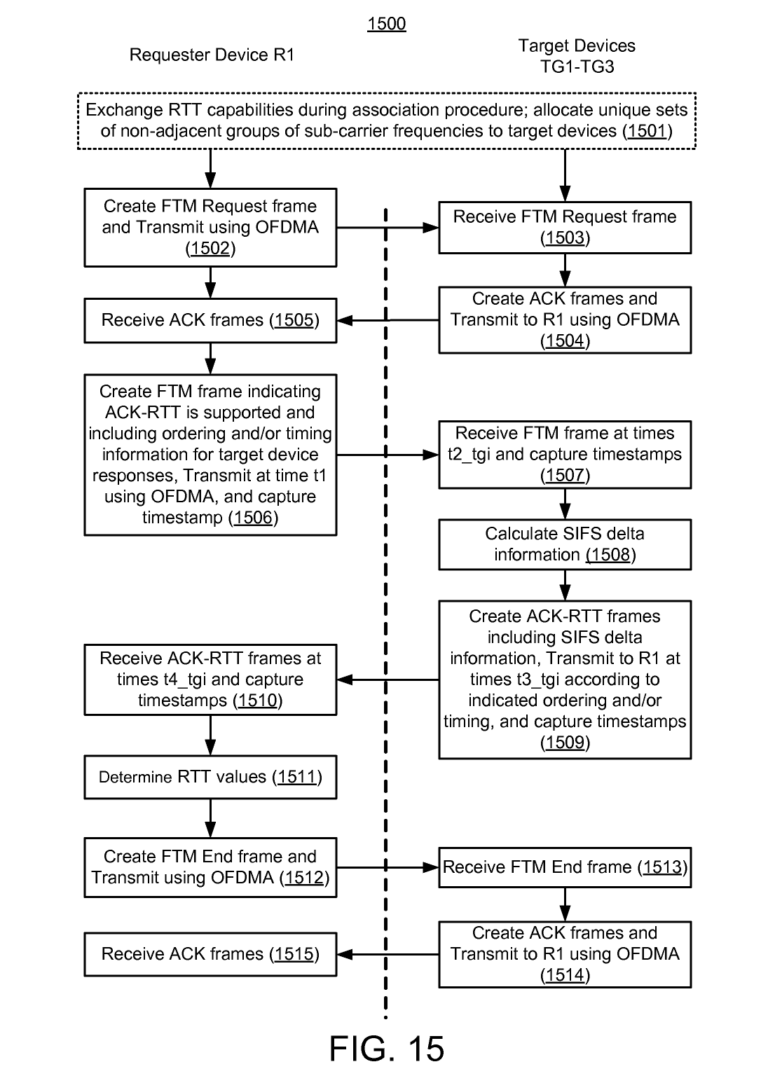

FIG. 15 shows an illustrative flowchart 1500 depicting the ranging operation of FIG. 8 in accordance with example embodiments. First, the requester device R1 and the target devices TG1-TG3 may exchange RTT capabilities during association (or after association using any suitable frames), and the requester device R1 (or another suitable device) may allocate a unique set of two or more non-adjacent groups of OFDM sub-carrier frequencies to each of the target devices TG1-TG3 (1501). The requester device R1 may create and transmit an FTM_REQ frame using OFDMA to target devices TG1-TG3 (1502). Each of target devices TG1-TG3 receives the FTM_REQ frame (1503), and then creates and transmits an ACK frame to requester device R1 (1504). The requester device R1 receives the ACK frames from target devices TG1-TG3 (1505).

Referring also to FIG. 8, at time t1, requester device R1 uses OFDMA to transmit an FTM frame to the target devices TG1-TG3 (1506). The FTM frame may indicate that ACK-RTT frames are supported, and may indicate the order in which and/or the times at which the target devices are to transmit corresponding ACK frames and/or may indicate the inter-frame spacing for each target device. Each of the target devices TG1-TG3 receives the FTM frame and captures the respective TOA information (e.g., as timestamps t2_tg1, t2_tg2, and t2_tg3, respectively) (1507). Each of target devices TG1-TG3 may calculate SIFS delta information (1508).

Each of target devices TG1-TG3 responds to receiving the FTM frame by creating and transmitting an ACK-RTT frame to the requester device R1 using the full bandwidth, for example, according to the ordering and timing information included in the ACK-RTT frame, and captures the TOD of the corresponding ACK frame (e.g., as timestamps t3_tg1, t3_tg2, and t3_tg3, respectively) (1509). Each of the ACK-RTT frames may include the SIFS delta information for a corresponding one of the target devices TG1-TG3. The requester device R1 receives the ACK-RTT frames transmitted from the target devices TG1-TG3, and captures the timestamps of the ACK-RTT frames (e.g., as timestamps t3_tg1, t3_tg2, and t3_tg3, respectively) (1510).

Requester device R1 then uses the received timing information (e.g., the SIFS delta information for target devices TG1-TG3) to determine RTT values between itself and each of target devices TG1-TG3 (1511). Requester device R1 may then create and transmit (using OFDMA) an FTM End frame to the target devices TG1-TG3 (1512). The FTM End frame may include the determined RTT values. Target devices TG1-TG3 receive the FTM End frame (1513), and respond by transmitting ACK frames to the requester device R1 (1514). The requester device R1 receives the ACK frames (1515).

Referring again to FIGS. 4-8, for some embodiments, target devices TG1-TG3 may create a special ACK frame, and report the difference between its actual SIFS duration and the “standard” SIFS duration in a new field of the special ACK frame. For example, FIG. 16A shows an example frame format for an ACK-RTT frame 1601 created in accordance with the example embodiments. The ACK-RTT frame 1601 may be used as the ACK-RTT frames depicted in FIG. 7 and/or as the ACK-RTT frames depicted in FIG. 8. The ACK-RTT frame 1601 is shown to include a 2 byte frame control field, a 2 byte duration field, a 6 byte receiver address (RA) field, a 3 byte SIFS delta field, and a 4 byte frame control sequence (FCS) field. The frame control field includes a 2 bit frame Type field and a 4 bit Sub type field. In accordance with the example embodiments, the Type field and the Sub type field may each be populated with currently unused or reserved bit patterns to indicate that the corresponding frame is one embodiment of the ACK-RTT frame 1601 of FIG. 16A. For example, while a bit pattern of “1011” for the Sub type field indicates an ACK frame, one of the unused or reserved bit patterns for the Sub type field may be used to indicate the ACK-RTT frame 1601 of FIG. 16A.

The SIFS delta field includes 24 bits that may be used to indicate a difference between the actual SIFS duration of a device and the “standard” SIFS duration. Thus, the SIFS delta value may be expressed as SIFS_{delta}=SIFS−SIFS_{standard}. For example, for the 2.4 GHz frequency band, SIFS_{delta}=SIFS−10 us; for the 5 GHz frequency band, SIFS_{delta}=SIFS−16 us; and for the 60 GHz frequency band, SIFS_{delta}=SIFS−3 us.

It is noted that the 24 bits of the SIFS delta field may represent a difference value of +/−900 ns when the per-bit resolution is 0.1 ns. For other embodiments, the SIFS delta field may include other numbers of bits and/or the per-bit resolution may be of values other than 0.1 ns.

Further, the number of bits denoted in each field of the ACK-RTT frame 1601 of FIG. 16A are illustrative of an example embodiment. For other embodiments, the fields of the ACK-RTT frame 1601 may include other suitable numbers of bits.

The SIFS information may also be provided by target devices TG1-TG3 in a block acknowledgment (BA) frame constructed in accordance with the example embodiments. For example, FIG. 16B shows an example frame format for a BA-RTT frame 1602 created in accordance with the example embodiments. The BA-RTT frame 1602 may be used as the ACK-RTT frames depicted in FIG. 7 and/or FIG. 8. The BA-RTT frame 1602 is shown to include a 2 byte frame control field, a 2 byte duration field, a 6 byte receiver address (RA) field, a 6 byte transmitter address (TA) field, a 3 byte SIFS delta field, a 2 byte BA control field, a variable length BA information field, and a 4 byte frame control sequence (FCS) field. The frame control field includes a 2 bit frame Type field and a 4 bit Sub type field. In accordance with the example embodiments, the Type field and the Sub type field may each be populated with currently unused or reserved bit patterns that indicate that the corresponding frame is a BA-RTT frame, as depicted in FIG. 16B. The SIFS delta field of the BA-RTT frame 1602 of FIG. 16B is similar to the SIFS delta field of the ACK-RTT frame 1601 of FIG. 16A. Further, the number of bits denoted in each field of the BA-RTT frame 1602 of FIG. 16B are illustrative of an example embodiment. For other embodiments, the fields of the BA-RTT frame 1602 may include other suitable numbers of bits.

Referencing actual SIFS values to the “standard” SIFS values, as described above with respect to FIGS. 16A-16B, may assume that the “standard” SIFS values are known and/or constant. For other embodiments, the actual SIFS values of a device may be referenced to historical values of actual SIFS values of the device (e.g., rather than to the “standard” SIFS values). For example, the actual SIFS values may be referenced to the median value of previously determined actual SIFS value of devices TG1-TG3, as described in more detail below with respect to FIGS. 17A-17B.

FIG. 17A shows an example frame format for an ACK-RTT frame 1701 created in accordance with the example embodiments. The ACK-RTT frame 1701 is similar to the ACK-RTT frame 1601 of FIG. 16A, except that the 3 byte SIFS delta field of the ACK-RTT frame 1601 is replaced by a 1 byte median SIFS field and a 2 byte SIFS delta field in the ACK-RTT frame 1701 of FIG. 17A. The Type field and the Sub type field of ACK-RTT frame 1701, which may each be populated with currently unused or reserved bit patterns that indicate that the corresponding frame is a ACK-RTT frame, may be different than the bit patterns used for the Type field and the Sub type field of ACK-RTT frame 1601 described above with respect to FIG. 16A.

The 8 bits of the median SIFS field may store a median SIFS value that indicates the median SIFS duration for a number of previous frame exchanges performed by target devices TG1-TG3. For example, if a 100 ns unit is used for each bit, the 8 bits of the median SIFS field may represent median SIFS durations up to 25.5 us. The 2 byte SIFS delta field may be used to indicate a difference between the actual SIFS value of the current frame exchange and the median SIFS value (e.g., stored in the median SIFS field). In this manner, the SIFS difference may be expressed as SIFS_{delta}=SIFS_{actual}−SIFS_{median}. Applicant notes that if a 0.1 ns per-bit resolution is used for SIFS_{delta}, the 16 bits of the SIFS delta field may represent a difference value of +/−900 ns. Further, the number of bits denoted in each field of the ACK-RTT frame 1701 of FIG. 17A are illustrative of an example embodiment. For other embodiments, the fields of the ACK-RTT frame 1701 may include other suitable numbers of bits.

The median SIFS information may also be provided in a block acknowledgment (BA) frame constructed in accordance with the example embodiments. For example, FIG. 17B shows an example frame format for a BA-RTT frame 1702 created in accordance with the example embodiments. For some embodiments, the BA-RTT frame 1702 may be the ACK-RTT frames depicted in FIG. 7 and/or FIG. 8. The BA-RTT frame 1702 is similar to the BA-RTT frame 1602 of FIG. 16B, except that the 3 byte SIFS delta field of BA-RTT frame 1602 is replaced by a 1 byte median SIFS field and a 2 byte SIFS delta field in the BA-RTT frame 1702 of FIG. 17B. The Type field and the Sub type field of BA-RTT frame 1702, which may each be populated with currently unused or reserved bit patterns that indicate that the corresponding frame is a BA-RTT frame, may be different than the bit patterns used for the Type field and the Sub type field of the ACK-RTT frame 1701 described above with respect to FIG. 17A. The 1 byte median SIFS field and the 2 byte SIFS delta field in the BA-RTT frame 1702 are similar to the 1 byte median SIFS field and the 2 byte SIFS delta field in the ACK-RTT frame 1701 of FIG. 17A. Further, the number of bits denoted in each field of the BA-RTT frame 1702 of FIG. 17B are illustrative of an example embodiment. For other embodiments, the fields of the BA-RTT frame 1702 may include other suitable numbers of bits.

To maximize ranging accuracy, the ranging operations described herein may be performed using a single transmit chain (and a single antenna) in both the requester device and the target devices, for example, to avoid errors resulting from cyclic shift diversity (CSD). For some embodiments, a bit in the data frame or FTM frame (e.g., that initiates the ranging operation) may be used to request the target devices to use a single transmit chain when transmitting the ACK-RTT or BA-RTT frame to the requester device. The bit may be the reserved bit 4 in the L-SIG, any of the reserved bits 7-15 in the service field in the data frame, or any other suitable bit in a frame sent from the requester device to the target device(s).

When requester device R1 and target devices TG1-TG3 exchange capabilities upon association with each other, their ability to support ACK-RTT and/or BA-RTT frames may also be exchanged, which in turn allows the devices to perform ranging operations in accordance with the example embodiments. For one example, in a WLAN for which one of requester device R1 and target devices TG1-TG3 is an AP and the others of requester device R1 and target devices TG1-TG3 are STAs, the requester device R1 and target devices TG1-TG3 are to always use ACK-RTT or BA-RTT frames instead of conventional ACK and BA frames when all devices support the use of ACK-RTT and/or BA-RTT frames. For another example, in a Wi-Fi Direct or peer-to-peer (P2P) network where one of requester device R1 and target devices TG1-TG3 is a group owner (GO) and the others of requester device R1 and target devices TG1-TG3 are client devices, the requester device R1 and target devices TG1-TG3 are to always use ACK-RTT or BA-RTT frames instead of conventional ACK and BA frames when all devices support the use of ACK-RTT and/or BA-RTT frames. In this manner, the target device (e.g., devices TG1-TG3 in the above example embodiments) may always embed SIFS information in acknowledgement frames, which in turn allows the requester device (e.g., requester device R1 in the above example embodiments) to perform ranging operations on any packet exchange, even without specifically requesting a particular ranging operation.

For some embodiments, one of the reserved bits in the extended capabilities element of frames exchanged during association may be used to indicate support of ACK-RTT and BA-RTT frames disclosed herein. For other embodiments, one of the reserved bits in the data frame sent from the requester device to the target devices (e.g., to initiate the ranging operation) may be used to indicate whether an ACK-RTT or BA-RTT frame is expected in response to the data frame. For one example, reserved bit 4 in the L-SIG field of the data frame may be used to request a response using an ACK-RTT or BA-RTT frame. For another example, any of the reserved bits 7-15 in the service field of the data frame may be used to request a response using an ACK-RTT or BA-RTT frame.

For yet other embodiments, one of the bits in the FTM frame sent from the requester device R1 to the target devices TG1-TG3 (e.g., to initiate the ranging operation) may be used to indicate whether an ACK-RTT or BA-RTT frame is expected in response to the data frame. For one example, reserved bit 4 in the L-SIG field of the frame may be used to request a response using an ACK-RTT or BA-RTT frame. For another example, any of the reserved bits 7-15 in the service field of the frame may be used to request a response using an ACK-RTT or BA-RTT frame. For yet another example, any of the reserved bits (or alternatively a newly added bit) in the FTM frame may be used to request a response using an ACK-RTT or BA-RTT frame.

The above embodiments are also applicable to devices compatible with high throughput/very high throughput (HT/VHT) protocols of the IEEE 802.11 standards. For such devices, one bit in the extended capabilities element of association frames, one of the reserved bits in the normal data frame, reserved bit 4 in the L-SIG field of the data frame, and/or any of the reserved bits 7-15 in the service field of the data frame may be used to indicate support for ACK-RTT and BA-RTT frames when operating according to HT/VHT protocols.

Alternatively, one of the bits in the FTM frame sent from the requester device R1 to the target devices TG1-TG3 (e.g., to initiate the ranging operation) may be used to indicate support for ACK-RTT and BA-RTT frames when operating according to HT/VHT protocols. For example, the reserved bit in the FTM frame may be bit 4 in the L-SIG field, may be any of the reserved bits 7-15 in the service field, and/or may be any of the reserved bits (or alternatively a newly added bit) in the FTM frame.

The above-described embodiments are also applicable to RTS/CTS frame exchanges, for example, where the target devices may report SIFS information to the requester device in the CTS frame.

The above-described embodiments are also applicable to control frames and data frames. For example, when an AP transmits a trigger frame to multiple STAs to request uplink multi-user (MU) frames, the STAs may report their SIFS information in the MU frames, for example, as a special element.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the disclosure.

The methods, sequences or algorithms described in connection with the aspects disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor.

Accordingly, one aspect of the disclosure can include a non-transitory computer readable media embodying a method for time and frequency synchronization in non-geosynchronous satellite communication systems. The term “non-transitory” does not exclude any physical storage medium or memory and particularly does not exclude dynamic memory (e.g., conventional random access memory (RAM)) but rather excludes only the interpretation that the medium can be construed as a transitory propagating signal.

While the foregoing disclosure shows illustrative aspects, it should be noted that various changes and modifications could be made herein without departing from the scope of the appended claims. The functions, steps or actions of the method claims in accordance with aspects described herein need not be performed in any particular order unless expressly stated otherwise. Furthermore, although elements may be described or claimed in the singular, the plural is contemplated unless limitation to the singular is explicitly stated. Accordingly, the disclosure is not limited to the illustrated examples and any means for performing the functionality described herein are included in aspects of the disclosure.

What is claimed is:

1. A method for performing simultaneous ranging operations between a wireless device and each of a plurality of target devices using orthogonal frequency-division multiple access (OFDMA), the method performed by the wireless device and comprising:
transmitting a fine timing measurement (FTM) frame to the plurality of target devices;
determining a time of departure (TOD) of the FTM frame;
receiving, from each of the plurality of target devices, a corresponding acknowledgement (ACK) frame;
determining a time of arrival (TOA) of each of the received ACK frames;
transmitting a trigger frame requesting an FTM response from each of the plurality of target devices;
receiving, from each of the plurality of target devices, a corresponding FTM response frame that includes the TOA of the FTM frame at the target device and includes the TOD of the corresponding ACK frame from the target device; and
determining a round-trip time (RTT) value between the wireless device and each of the plurality of target devices based, at least in part, on the TOD of the FTM frame, the TOA of the FTM frame at the target device, the TOD of the corresponding ACK frame from the target device, and the TOA of the corresponding ACK frame at the wireless device.

2. The method of claim 1, further comprising:
transmitting, to each of the plurality of target devices, an FTM end frame including the determined RTT value between the wireless device and the target device.

3. The method of claim 1, the FTM frame including synchronization information indicating a time at which each of the plurality of target devices is to transmit its corresponding ACK frame to the wireless device.

4. The method of claim 1, the FTM frame indicating an order in which the plurality of target devices are to transmit the corresponding ACK frames to the wireless device.

5. The method of claim 1, each of the ACK frames comprising an ACK-RTT frame including information indicative of a short Interframe spacing (SIFS) duration of the corresponding target device.

6. The method of claim 1, the FTM frame transmitted using at least two non-adjacent groups of sub-carrier frequencies.

7. The method of claim 1, each of the ACK frames transmitted using at least two unique and non-adjacent groups of sub-carrier frequencies.

8. The method of claim 1, further comprising:
allocating a unique set of two or more non-adjacent groups of orthogonal frequency-division multiplexing (OFDM) sub-carrier frequencies to each of the plurality of target devices.

9. A wireless device configured to perform simultaneous ranging operations with each of a plurality of target devices using orthogonal frequency-division multiple access (OFDMA), the wireless device comprising:
one or more processors; and
a memory configured to store instructions that, when executed by the one or more processors, cause the wireless device to:
transmit a fine timing measurement (FTM) frame to the plurality of target devices;
determine a time of departure (TOD) of the FTM frame;
receive, from each of the plurality of target devices, a corresponding acknowledgement (ACK) frame;
determine a time of arrival (TOA) of each of the received ACK frames;
transmit a trigger frame requesting an FTM response from each of the plurality of target devices;
receive, from each of the plurality of target devices, a corresponding FTM response frame that includes the TOA of the FTM frame at the target device and includes the TOD of the corresponding ACK frame from the target device; and
determine a round-trip time (RTT) value between the wireless device and each of the plurality of target devices based, at least in part, on the TOD of the FTM frame, the TOA of the FTM frame at the target device, the TOD of the corresponding ACK frame from the target device, and the TOA of the corresponding ACK frame at the wireless device.

10. The wireless device of claim 9, the FTM frame including synchronization information indicating a time at which each of the plurality of target devices is to transmit its corresponding ACK frame to the wireless device.

11. The wireless device of claim 9, the FTM frame indicating an order in which the plurality of target devices are to transmit the corresponding ACK frames to the wireless device.

12. The wireless device of claim 9, the FTM frame transmitted using at least two non-adjacent groups of sub-carrier frequencies.

13. The wireless device of claim 9, each of the ACK frames transmitted using at least two unique and non-adjacent groups of sub-carrier frequencies.

14. The wireless device of claim 9, wherein execution of the instructions causes the wireless device to further:
allocate a unique set of two or more non-adjacent groups of orthogonal frequency-division multiplexing (OFDM) sub-carrier frequencies to each of the plurality of target devices.

15. A wireless device configured to perform simultaneous ranging operations with each of a plurality of target devices using orthogonal frequency-division multiple access (OFDMA), the wireless device comprising:
means for transmitting a fine timing measurement (FTM) frame to the plurality of target devices;
means for determining a time of departure (TOD) of the FTM frame;
means for receiving, from each of the plurality of target devices, a corresponding acknowledgement (ACK) frame;
means for determining a time of arrival (TOA) of each of the received ACK frames;
means for transmitting a trigger frame requesting an FTM response from each of the plurality of target devices;
means for receiving, from each of the plurality of target devices, a corresponding FTM response frame that includes the TOA of the FTM frame at the target device and includes the TOD of the corresponding ACK frame from the target device; and
means for determining a round-trip time (RTT) value between the wireless device and each of the plurality of target devices based, at least in part, on the TOD of the FTM frame, the TOA of the FTM frame at the target device, the TOD of the corresponding ACK frame from the target device, and the TOA of the corresponding ACK frame at the wireless device.

16. The wireless device of claim 15, the FTM frame including synchronization information indicating a time at which each of the plurality of target devices is to transmit its corresponding ACK frame to the wireless device.

17. The wireless device of claim 15, the FTM frame indicating an order in which the plurality of target devices are to transmit the corresponding ACK frames to the wireless device.

18. The wireless device of claim 15, the FTM frame transmitted using at least two non-adjacent groups of sub-carrier frequencies.

19. The wireless device of claim 15, each of the ACK frames transmitted using at least two unique and non-adjacent groups of sub-carrier frequencies.

20. The wireless device of claim 15, further comprising:
means for allocating a unique set of two or more non-adjacent groups of orthogonal frequency-division multiplexing (OFDM) sub-carrier frequencies to each of the plurality of target devices.
